(19) United States
(12) Patent Application Publication
(10) Pub. No.: US 2024/0353096 A1
(43) Pub. Date: Oct. 24, 2024

(54) STEAM TURBINE ROTOR BLADE THINNING AMOUNT MANAGING APPARATUS

(71) Applicant: TOSHIBA ENERGY SYSTEMS & SOLUTIONS CORPORATION, Kawasaki-shi (JP)

(72) Inventors: Yasuteru KAWAI, Yokohama Kanagawa (JP); Yasutaka KAWADA, Kawasaki Kanagawa (JP); Shota NAKAJIMA, Yokohama Kanagawa (JP); Tetsuya MAKINO, Kawasaki Kanagawa (JP); Yusuke SUZUKI, Yokohama Kanagawa (JP); Tsukasa TAKEUCHI, Yokohama Kanagawa (JP); Hiroyuki ICHIKAWA, Koganei Tokyo (JP); Yasunori ONO, Yokohama Kanagawa (JP)

(73) Assignee: TOSHIBA ENERGY SYSTEMS & SOLUTIONS CORPORATION, Kawasaki-shi (JP)

(21) Appl. No.: 18/414,609

(22) Filed: Jan. 17, 2024

(30) Foreign Application Priority Data
Apr. 24, 2023 (JP) 2023-071070

(51) Int. Cl. F22B 35/18; F01D 5/02

(52) U.S. Cl. CPC F22B 35/18; F01D 5/021; F05D 2220/31

(57) ABSTRACT

A thinning amount managing apparatus in an embodiment for managing an amount of thinning of a first-stage rotor blade of a steam turbine caused by solid particles contained in working steam for working the steam turbine. The thinning amount managing apparatus includes a display information generation section configured to generate display information for displaying: past thinning amount related information indicating information on a past thinning amount of the first-stage rotor blade from the past to the present calculated based on measured information; and future thinning amount related information indicating information on a future thinning amount of the first-stage rotor blade calculated based on a future operating condition input via a user interface screen and the past thinning amount related information.

### CROSS REFERENCE TO RELATED APPLICATIONS

This application is based upon and claims the benefit of priority from Japanese Patent Application No. 2023-071070, filed on Apr. 24, 2023; the entire contents of which are incorporated herein by reference.

### FIELD

Embodiments described herein relate generally to a steam turbine rotor blade thinning amount managing apparatus.

### BACKGROUND

The steam to be introduced into a steam turbine may contain solid particles, which are oxidized scales separated from the surfaces of boiler pipes, or the like. For example, even in a steam valve provided with a strainer, the strainer fails to capture all the solid particles. Therefore, the steam mixed with solid particles flows into the steam turbine.

The surface of a rotor blade may be eroded by collision with the steam mixed with solid particles. This solid particle erosion (SPE: Solid Particle Erosion) is a type of wear phenomenon, and thins the surface of the rotor blade over time. The progress of thinning caused by SPE may develop into the occurrence of cracks or scattering of pieces of the rotor blade. The thinning caused by SPE is noticeably observed at the first-stage rotor blades of a high-pressure turbine or an intermediate-pressure turbine.

Conventionally, the amount of thinning caused by SPE has been inspected during periodic inspections. Then, when the thinning amount exceeds a predetermined threshold, replacement of the rotor blade is recommended. Incidentally, in the following, the thinning caused by SPE is simply referred to as thinning. Further, the amount of thinning caused by SPE is simply referred to as a thinning amount.

In recent years, the introduction of renewable energy has been accelerated in power generation facilities as a measure to reduce carbon dioxide (CO₂) emissions. In power generation using renewable energy, the amount of power generated varies depending on the weather or other factors. Therefore, in recent years, thermal power generation facilities have shifted to the operation mainly with regulated thermal power in order to compensate for the unstable power supply in the power generation using renewable energy.

As described above, the thermal power generation facilities including steam turbines are shifting from the operation mainly with a rated load to the operation mainly with a regulated load, and thus, there is a risk that thinning will further progress at the rotor blades of steam turbines.

A user who manages a steam turbine in a thermal power generation facility can learn the thinning amount of the rotor blade during a periodic inspection. However, in a conventional steam turbine management system, the user is not able to learn information on the predicted thinning amount of the rotor blade from a past periodic inspection to the present, or information on the predicted future thinning amount of the rotor blade based on future operating conditions of the actual steam turbine. Furthermore, in the conventional steam turbine management system, the user is not able to learn information on the time when the thinning amount reaches a threshold at which the rotor blade should be replaced in the future, or other information.

### BRIEF DESCRIPTION OF THE DRAWINGS

FIG. 1 is a system diagram schematically illustrating a configuration of a steam turbine facility including a thinning amount managing apparatus in a first embodiment.

FIG. 2 is a block diagram illustrating a functional configuration of the thinning amount managing apparatus in the first embodiment.

FIG. 3 is a view illustrating one example of an input screen for future operating conditions to be displayed on a user interface in the thinning amount managing apparatus in the first embodiment.

FIG. 4 is a view illustrating one example of an input screen for inputting periodic inspection results regarding thinning to the thinning amount managing apparatus in the first embodiment.

FIG. 5 is a view illustrating one example of the input screen for inputting periodic inspection results regarding thinning to the thinning amount managing apparatus in the first embodiment.

FIG. 6 is a flowchart for explaining the flow of arithmetic operation of a past thinning amount in a fixed-cycle thinning amount arithmetic operation section of the thinning amount managing apparatus in the first embodiment.

FIG. 7 is a flowchart for explaining the flow of arithmetic operation of a future thinning amount in a future thinning amount arithmetic operation section of the thinning amount managing apparatus in the first embodiment.

FIG. 8 is a view for explaining a method of calculating a recommended inspection time, a recommended replacement time, a recommended preparation time, and a preparation threshold in the future thinning amount arithmetic operation section of the thinning amount managing apparatus in the first embodiment.

FIG. 9 is a view for explaining the method of calculating the recommended inspection time, the recommended replacement time, the recommended preparation time, and the preparation threshold in the future thinning amount arithmetic operation section of the thinning amount managing apparatus in the first embodiment.

FIG. 10 is a view illustrating one example of a display screen on which display information was displayed as of the date of installation of the thinning amount managing apparatus in the first embodiment.

FIG. 11 is a flowchart for explaining a method of fixed-cycle thinning amount arithmetic operation processing in the thinning amount managing apparatus in the first embodiment.

FIG. 12 is a view illustrating one example of a display screen on which arithmetic operation results have been displayed in the thinning amount managing apparatus in the first embodiment.

FIG. 13 is a view illustrating one example of a display screen displaying arithmetic operation results in post-inspection arithmetic operation processing in the thinning amount managing apparatus in the first embodiment.

FIG. 14 is a flowchart for explaining the method of the fixed-cycle thinning amount arithmetic operation processing in the thinning amount managing apparatus in the first embodiment.

FIG. 15 is a flowchart for explaining a method of future thinning amount arithmetic operation processing in the thinning amount managing apparatus in the first embodiment.

FIG. 16 is a flowchart for explaining the method of the future thinning amount arithmetic operation processing in the thinning amount managing apparatus in the first embodiment.

FIG. 17 is a flowchart for explaining a method of future thinning amount arithmetic operation processing in the thinning amount managing apparatus in a second embodiment.

FIG. 18 is a flowchart for explaining the method of the future thinning amount arithmetic operation processing in the thinning amount managing apparatus in the second embodiment.

FIG. 19 is a view illustrating one example of a display screen in the thinning amount managing apparatus in the second embodiment.

FIG. 20 is a view illustrating one example of a selection screen for selecting a comparison arithmetic operation result to be displayed on the user interface in the thinning amount managing apparatus in the second embodiment.

### DETAILED DESCRIPTION

There will be explained embodiments of the present invention below with reference to the drawings.

In one embodiment, a steam turbine rotor blade thinning amount managing apparatus for managing an amount of thinning of a first-stage rotor blade of a steam turbine caused by solid particles contained in working steam for working the steam turbine. The steam turbine rotor blade thinning amount managing apparatus includes a display information generation section configured to generate display information for displaying: past thinning amount related information indicating information on a past thinning amount of the first-stage rotor blade from the past to the present calculated based on measured information; and future thinning amount related information indicating information on a future thinning amount of the first-stage rotor blade calculated based on a future operating condition input via a user interface screen and the past thinning amount related information.

### First Embodiment

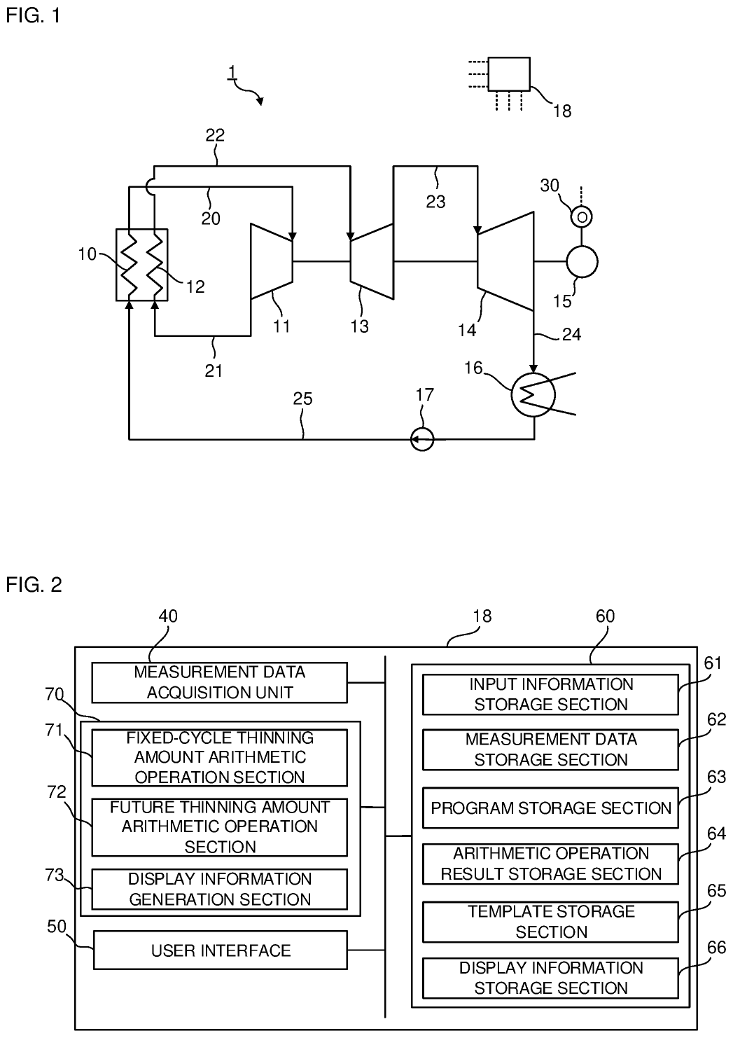

FIG. 1 is a system diagram schematically illustrating a configuration of a steam turbine facility 1 including a thinning amount managing apparatus 18 in the first embodiment. Incidentally, the thinning amount managing apparatus 18 functions as a thinning amount managing apparatus for a rotor blade of a steam turbine. Further, the thinning amount managing apparatus 18 manages the amount of thinning of the rotor blade caused by solid particles such as oxidized scales contained in working steam that operates the steam turbine.

As illustrated in FIG. 1, the steam turbine facility 1 includes a boiler 10, a high-pressure turbine 11, a reheater 12, an intermediate-pressure turbine 13, a low-pressure turbine 14, a generator 15, a condenser 16, a feed pump 17, and the thinning amount managing apparatus 18. Here, rotor blades of the high-pressure turbine 11 and the intermediate-pressure turbine 13 function as the rotor blades of the steam turbine whose amount of thinning caused by SPE (Solid Particle Erosion) is managed in the thinning amount managing apparatus 18.

In the high-pressure turbine 11 and the intermediate-pressure turbine 13, thinning tends to progress at the rotor blade at the first-stage turbine stage. Therefore, the thinning amount managing apparatus 18 manages, for example, the thinning amount at the first-stage rotor blades of the high-pressure turbine 11 and the intermediate-pressure turbine 13. Incidentally, the thinning amount managing apparatus 18 may manage the thinning amount at the rotor blades at other turbine stages that are subjected to SPE, in addition to the rotor blades at the first stage. Incidentally, the rotor blade to be managed is also the rotor blade to be predicted whose thinning amount is predicted in the thinning amount managing apparatus 18.

The steam turbine facility 1 includes the thinning amount managing apparatus 18 and an output detector 30 as a thinning amount management system for calculating and managing the thinning amount of the rotor blade in the steam turbine.

The boiler 10 heats feedwater to generate steam, and leads the steam to a main steam pipe 20. The high-pressure turbine 11 is turned by the steam introduced from the main steam pipe 20 and discharges the steam to a low-temperature reheat steam pipe 21. The reheater 12 reheats the steam introduced from the low-temperature reheat steam pipe 21 and leads the steam to a high-temperature reheat steam pipe 22.

The intermediate-pressure turbine 13 is turned by the steam introduced from the high-temperature reheat steam pipe 22 and discharges the steam to a crossover pipe 23. The low-pressure turbine 14 is turned by the steam introduced from the crossover pipe 23 and discharges the steam to an exhaust pipe 24. The generator 15 generates electric power by being driven by the high-pressure turbine 11, the intermediate-pressure turbine 13, and the low-pressure turbine 14. For example, the generator 15 is coaxially connected to the high-pressure turbine 11, the intermediate-pressure turbine 13, and the low-pressure turbine 14.

The condenser 16 condenses the steam introduced from the exhaust pipe 24 into condensed water. The feed pump 17 supplies the condensed water from the condenser 16 to the boiler 10 through a feed pipe 25 as feedwater.

The thinning amount managing apparatus 18 is an apparatus for calculating and managing the amount of thinning caused by SPE at a rotor blade in a steam turbine. Incidentally, details of the thinning amount managing apparatus 18 will be described later.

The output detector 30 detects the electrical output of the generator 15 to output a detection signal of the detected electrical output to the thinning amount managing apparatus 18.

Next, the thinning amount managing apparatus 18 is explained.

FIG. 2 is a block diagram illustrating a functional configuration of the thinning amount managing apparatus 18 in the first embodiment. The thinning amount managing apparatus 18 is an apparatus that predicts and manages the thinning amount from the past to the present based on operation data of the actual steam turbine and the future thinning amount based on operating conditions assumed in the future. Further, the thinning amount managing apparatus 18 generates display information for displaying predicted results such as the thinning amount on a display part, for example.

As illustrated in FIG. 2, the thinning amount managing apparatus 18 includes a measurement data acquisition unit 40, a user interface 50, a storage unit 60, and an arithmetic operation unit 70.

The measurement data acquisition unit 40 is an interface that acquires the detection signal related to the electrical output from the output detector 30. The measurement data acquisition unit 40 has a function of converting the acquired detection signal into electrical output information based on the acquired detection signal related to the electrical output. The electrical output information includes, for example, in addition to the information on the electrical output, information on the time when the electrical output was obtained, that is, the operating time of the steam turbine.

Further, the measurement data acquisition unit 40 is, for example, an interface that acquires detection signals related to the startup counts of the high-pressure turbine 11 and the intermediate-pressure turbine 13 from the management system of the steam turbine facility 1. The measurement data acquisition unit 40 has a function of converting the acquired detection signal into startup count information based on the acquired detection signal related to the startup count.

Here, examples of the startup of the steam turbine include cold startup, warm startup, and hot startup. The cold startup refers to the case where operation is started after being stopped for a long period of time due to, for example, a periodic inspection or another reason. As the suspension period before starting the cold startup, for example, a suspension period of more than three days can be cited as an example. The warm startup refers to, for example, the case where operation is stopped on a weekend and started at the beginning of next week. As the suspension period before starting the warm startup, for example, a suspension period of 12 hours to 36 hours can be cited as an example. The hot startup refers to, for example, the case where operation is stopped late at night and started next morning. As the suspension period before starting the hot startup, for example, a suspension period of less than 12 hours can be cited as an example. Incidentally, the case where the output of the generator 15 is equal to or less than a predetermined threshold is considered to be stopped.

The measurement data acquisition unit 40 acquires the above-described detection signal at predetermined time intervals. The measurement data acquisition unit 40 acquires the detection signal at one-hour intervals, for example. The measurement data acquisition unit 40 outputs the converted startup count information and electrical output information to a measurement data storage section 62 of the storage unit 60.

The user interface 50 includes a display part that displays various pieces of information to a user (manager), and an input device through which the user inputs various pieces of information. The display part is configured by a display, and the like, for example. Further, the display part may be configured by a touch panel having a function as a display screen and a function as an input device that allows direct input to the screen. The input device is configured by a keyboard, a mouse, and the like, for example.

The storage unit 60 includes an input information storage section 61, the measurement data storage section 62, a program storage section 63, an arithmetic operation result storage section 64, a template storage section 65, and a display information storage section 66. The storage unit 60 is fabricated by, for example, a hard disk drive, a nonvolatile memory device, or the like. The storage unit 60 may be in a form that is not physically integrated with the thinning amount managing apparatus 18, but is connected thereto via a not-illustrated network.

The input information storage section 61 stores, for example, future operating conditions, various setting conditions, and so on that are input via the user interface 50. Further, the input information storage section 61 stores, for example, various setting conditions, design information of the rotor blade to be managed, information on periodic inspection results related to the thinning amount, and so on, which are input from an input device at a manufacturer that manufactures the thinning amount managing apparatus 18.

Here, the future operating conditions are used in arithmetic operations to predict the future thinning amount. The future operating conditions are future operating conditions in the steam turbine facility 1. The future operating condition includes an operating time per day (24 hours) for each classified load and an annual availability factor. Further, the future operating condition includes a startup count per year.

Examples of the future operating condition include a preset default operation mode, a customized operation mode in which a user arbitrarily sets an operating time for each classified load, an annual availability factor, and a startup count, and so on. Incidentally, even in the default operation mode, the user arbitrarily sets the startup count.

Here, the “classified load” refers to a load obtained by classifying the load range of a steam turbine (for example, a range from 0% load to 100% load) in units of predetermined load (for example, in units of 10% load). For example, when the load range of the steam turbine from 0% load to 100% load is classified in units of 10% load, the classified loads are 10% load, 20% load, 30% load, 40% load, 50% load, 60% load, 70% load, 80% load, 90% load, and 100% load.

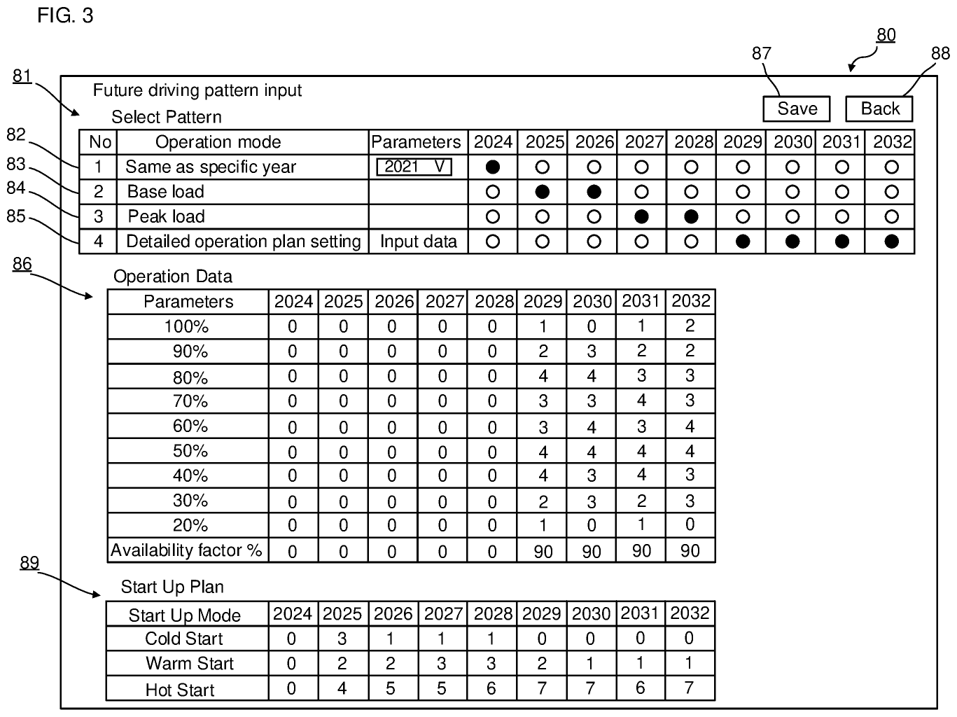

FIG. 3 is a view illustrating one example of an input screen 80 for future operating conditions to be displayed on the user interface 50 in the thinning amount managing apparatus 18 in the first embodiment.

In FIG. 3, as the default operation mode, for example, a past operation performance mode (Same as specific year) 82, a base load operation mode (Base load) 83, and a peak load operation mode (Peak load) 84 have been set. As the customized operation mode, a detailed operation setting mode (Detailed operation plan setting) 85 has been set.

The input screen 80 illustrated in FIG. 3 is one example of a screen selected and input by the user via the user interface 50. In Select Pattern 81 at the top of FIG. 3, the user selects a white circle in the column of Operation mode to be selected for each year and changes it to a black circle. In the input screen 80 illustrated in FIG. 3, the past operation performance mode 82 has been selected for year 2024, the base load operation mode 83 has been selected for year 2025 and year 2026, the peak load operation mode 84 has been selected for year 2027 and year 2028, and the detailed operation setting mode 85 has been selected for year 2029 to year 2032.

Incidentally, although the period up to year 2032 has been illustrated in FIG. 3, the present invention is not limited to this period. For example, a further period such as a period of year 2040 may be set as the period.

The past operation performance mode 82 is a mode in which operation is performed in the same operation pattern as that of the selected year. In the past operation performance mode 82, the operation mode is set based on the classified loads in units of 10% load and the operating time in each classified load, which are calculated from the operation data from January to December of the selected year. Further, in the past operation performance mode 82, the operation mode is set based on the availability factor (Availability factor) of the selected year. Further, in the past operation performance mode 82, the operation mode is set based on the startup count of each of the cold startup, the warm startup, and the hot startup of the selected year. Incidentally, in FIG. 3, the operation pattern for year 2021 has been selected.

Here, the availability factor is a ratio of the number of days in which the steam turbine facility 1 is operated in one year for each year. That is, the availability factor is a value obtained by dividing the number of days in which the steam turbine facility 1 is operated in one year by 365 days and expressing the result as a percentage of 100.

The base load operation mode 83 is a mode in which operation is performed at a high load in the range of 70% load to 100% load, for example. In the base load operation mode 83, classified loads, which are obtained by classifying the load range from 70% load to 100% load in units of 10% load, are set, for example. Further, in the base load operation mode 83, the availability factor has been set for each year.

Incidentally, the base load operation mode 83 is a default value, and is set with reference to past operation data in the steam turbine facility 1, for example. Further, in the base load operation mode 83, the startup count is arbitrarily set for each Start Up Mode of the cold startup, the warm startup, and the hot startup illustrated in the columns of Start Up Plan 89. Then, as the startup count, conditions arbitrarily set by the user in the columns of Start Up Plan 89 are used. As illustrated in FIG. 3, the user inputs the startup count into the column of each Start Up Mode for year 2025 and year 2026 in Start Up Plan 89. The base load operation mode 83 is set, for example, on an annual basis.

Table 1 illustrates one example of the base load operation mode 83.

TABLE 1

| | | Year | | | | | | | | | | | | | | |
|---|---|---|---|---|---|---|---|---|---|---|---|---|---|---|---|---|
| | | 2024 | | 2025 | 2026 | | 2027 | 2028 | | 2029 | | 2030 | 2031 | | 2032 | |
| Load | 100% | 3 | hour | 4 hour | 5 | hour | 6 hour | 4 | hour | 3 | hour | 6 hour | 5 | hour | 4 | hour |
| | 90% | 10 | hour | 9 hour | 11 | hour | 8 hour | 12 | hour | 11 | hour | 9 hour | 11 | hour | 10 | hour |
| | 80% | 9 | hour | 8 hour | 7 | hour | 8 hour | 5 | hour | 8 | hour | 8 hour | 5 | hour | 8 | hour |
| | 70% | 2 | hour | 3 hour | 1 | hour | 2 hour | 3 | hour | 2 | hour | 1 hour | 3 | hour | 2 | hour |

| | | | | | | | | | |
|---|---|---|---|---|---|---|---|---|---|
| Availability factor, % | 89 | 89 | 89 | 89 | 89 | 89 | 89 | 89 | 89 |

Table 1 illustrates one example in which the operating time per day (24 hours) is set for each classified load in each year from year 2024 to year 2032. As illustrated in Table 1, for example, as the base load operation mode 83 for year 2024, 100% load (rated load): 3 hours, 90% load: 10 hours, 80% load: 9 hours, and 70% load: 2 hours have been set. Further, the availability factor has been set to 89%.

Incidentally, although there has been explained one example in which the load range from 100% load to 70% load is classified in units of 10% load as the base load operation mode 83 here, the present invention is not limited to this setting. The load range in the base load operation mode 83 may be set wider or narrower than the range in the above-described example. Further, the load unit may be set wider or narrower than the 10% load unit. Further, the number of years to be set may be smaller or larger than the number of years set in Table 1.

The peak load operation mode 84 is a mode in which operation is performed with load variations in the range from a low load to a rated load (100% load). In the peak load operation mode 84, for example, classified loads, which are obtained by classifying the load range from 100% load to 20% load in units of 10% load, are set. The peak load operation mode 84 is set on an annual basis. Table 2 illustrates one example of the peak load operation mode 84.

TABLE 2

| | | Year | | | | | | | | |
|---|---|---|---|---|---|---|---|---|---|---|
| | | 2024 | 2025 | 2026 | 2027 | 2028 | 2029 | 2030 | 2031 | 2032 |
| Load | 100% | 1 hour | 1 hour | 1 hour | 1 hour | 1 hour | 1 hour | 1 hour | 1 hour | 1 hour |
| | 90% | 5 hour | 5 hour | 5 hour | 5 hour | 5 hour | 6 hour | 7 hour | 7 hour | 4 hour |
| | 80% | 2 hour | 2 hour | 2 hour | 2 hour | 2 hour | 2 hour | 2 hour | 2 hour | 2 hour |
| | 70% | 1 hour | 1 hour | 1 hour | 2 hour | 2 hour | 1 hour | 1 hour | 1 hour | 2 hour |
| | 60% | 1 hour | 1 hour | 1 hour | 1 hour | 1 hour | 1 hour | 1 hour | 1 hour | 1 hour |
| | 50% | 1 hour | 1 hour | 2 hour | 2 hour | 2 hour | 1 hour | 1 hour | 2 hour | 2 hour |
| | 40% | 4 hour | 2 hour | 2 hour | 2 hour | 3 hour | 3 hour | 2 hour | 2 hour | 2 hour |
| | 30% | 8 hour | 3 hour | 3 hour | 3 hour | 3 hour | 8 hour | 3 hour | 2 hour | 3 hour |
| | 20% | 1 hour | 8 hour | 7 hour | 6 hour | 5 hour | 1 hour | 6 hour | 6 hour | 7 hour |

| | | | | | | | | | |
|---|---|---|---|---|---|---|---|---|---|
| Availability factor, % | 89 | 89 | 89 | 89 | 89 | 89 | 89 | 89 | 89 |

In Table 2, the operating time per day (24 hours) has been set for each classified load in each year from year 2024 to year 2032. For example, as the peak load operation mode 84 in year 2024, 100% load (rated load): 1 hour, 90% load: 5 hours, 80% load: 2 hours, 70% load: 1 hour, 60% load: 1 hour, 50% load: 1 hour, 40% load: 4 hours, 30% load: 8 hours, and 20% load: 1 hour have been set. Further, the availability factor has been set to 89%.

Incidentally, the peak load operation mode 84 is a default value, and is set with reference to past operation data in the steam turbine facility 1, for example. Further, in the peak load operation mode 84, as the startup count, conditions arbitrarily set by the user in the columns of Start Up Plan 89 are used. As illustrated in FIG. 3, the user inputs the startup count into the column of each Start Up Mode for year 2027 and year 2028 in Start Up Plan 89.

Further, although there has been explained one example in which the load range from 100% load to 20% load is classified in units of 10% load as the peak load operation mode 84 here, the present invention is not limited to this setting. The load range in the peak load operation mode 84 may be set wider or narrower than the range in the above-described example. Further, the load unit may be set wider or narrower than the 10% load unit. Further, the number of years to be set may be smaller or larger than the number of years set in Table 2.

In the detailed operation setting mode 85, the operating time per day (24 hours) is arbitrarily set for each classified load illustrated in the column of Operation Data 86 in FIG. 3. Further, the availability factor is also set arbitrarily. The user inputs the operating time for each classified load in the column of year in the detailed operation setting mode 85.

Further, as the startup count, conditions arbitrarily set by the user in the columns of Start Up Plan 89 are used. As illustrated in FIG. 3, the user inputs the startup count into the column of each Start Up Mode for year 2029 to year 2032 in Start Up Plan 89.

Incidentally, although there has been explained one example in which the load range from 100% load to 20% load is classified in units of 10% load as Operation Data 86 in the detailed operation setting mode 85 here, the present invention is not limited to this setting. The load range in the detailed operation setting mode 85 may be set wider or narrower than the range in the above-described example. Further, the load unit may be set wider or narrower than the 10% load unit.

Here, the user who has input the above-described future operating condition presses a Save button 87 in FIG. 3. The user interface 50 receives input from the Save button 87 and outputs information related to the future operating condition to the input information storage section 61. The input information storage section 61 receives and stores the information related to the future operating condition.

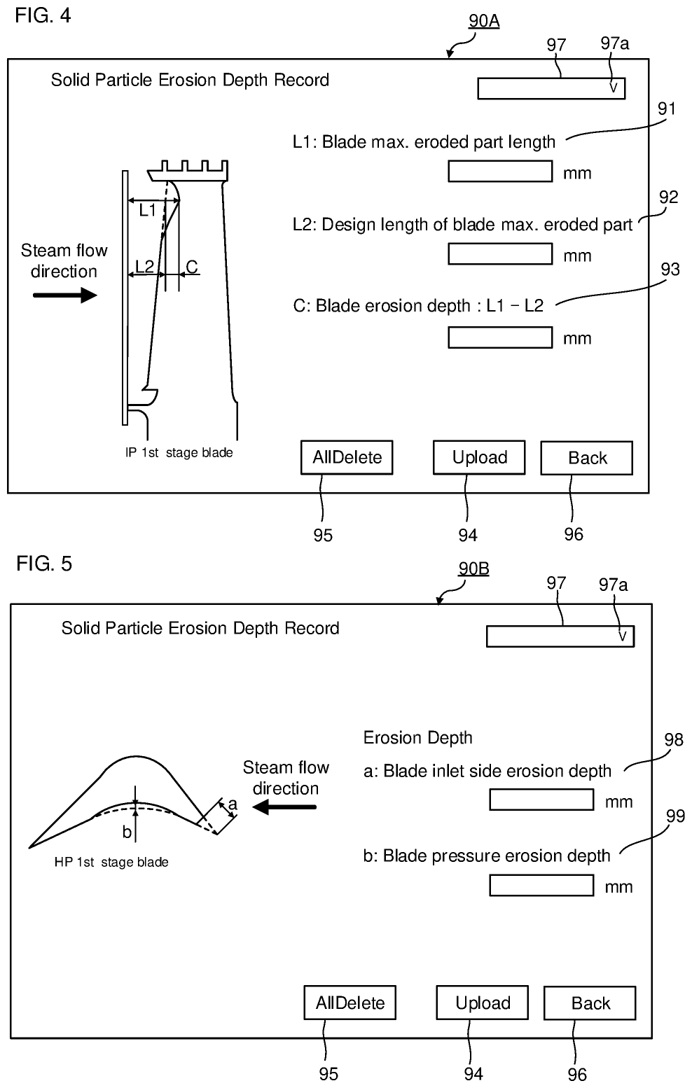

Further, the input information storage section 61 stores information on periodic inspection results related to the thinning amount, and so on. Here, FIG. 4 and FIG. 5 each are a view illustrating one example of an input screen 90 for inputting periodic inspection results regarding thinning to the thinning amount managing apparatus 18 in the first embodiment. Incidentally, FIG. 4 is one example of the input screen 90 regarding a first-stage rotor blade of the intermediate-pressure turbine, and FIG. 5 is one example of the input screen 90 regarding a first-stage rotor blade of the high-pressure turbine.

For example, the periodic inspection results are input by the manufacturer. The input screens 90A and 90B illustrated in FIG. 4 and FIG. 5 are displayed on, for example, an operation screen of the input device at the manufacturer. Then, the information related to the periodic inspection results from the input device at the manufacturer is output to the input information storage section 61. The input information storage section 61 receives and stores the information related to the periodic inspection results. Incidentally, the input device at the manufacturer has been set to be able to access the thinning amount managing apparatus 18.

First, the input screen 90A in FIG. 4 is explained.

L1 illustrated on the input screen 90A in FIG. 4 is the distance between a downstream end surface of a reference plate provided on the leading edge side of the rotor blade and a blade surface of a portion in which thinning has progressed the most in the axial direction of a turbine rotor (steam flow direction in the drawing). The reference plate is provided perpendicularly to the axial direction of the turbine rotor (steam flow direction in the drawing).

L2 is the distance between the downstream end surface of the reference plate and a blade surface (leading edge) of a new rotor blade at the blade height position of the portion in which thinning has progressed the most. Incidentally, in the input screen 90A, the blade surface (leading edge) of the new rotor blade is illustrated by a dotted line. In the new rotor blade, the value of L2 varies depending on the specifications of the blade or the blade height position. Therefore, after the blade height position at L1 is specified, L2 is specified based on the blade height position and the design information of the new rotor blade. Here, the blade height is the height of the rotor blade in a direction perpendicular to the axial direction of the turbine rotor (radial direction) in a state where the rotor blade is planted on the turbine rotor. The height of the rotor blade is, for example, the height in the radially outer direction from the end on the radially inner side of a blade effective portion of the rotor blade.

Here, L1 and L2 at the rotor blade whose thinning has progressed the most among a plurality of rotor blades planted in the circumferential direction are input.

C is the depth of erosion in the axial direction of the turbine rotor, that is, the thinning amount, obtained by subtracting L2 from L1.

Numerical values based on the periodic inspection results are input into numerical value columns 91 and 92 of L1 and L2. After inputting the numerical values of L1 and L2, the thinning amount is displayed in a numerical value column 93 of C.

Then, the input device at the manufacturer receives input from an Upload button 94 and outputs information related to the periodic inspection results to the input information storage section 61. The input information storage section 61 receives and stores the information related to the periodic inspection results. Incidentally, the input device at the manufacturer receives input from an All Delete button 95 and deletes, for example, the numerical values in the numerical value columns 91, 92, and 93 of L1, L2, and C. Incidentally, a Back button 96 on the input screen 90 is a button to be pressed when returning to a later-described display screen 100 without pressing the Upload button 94.

Further, on the input screen 90A, a selection display portion 97 for selecting the type of rotor blade is displayed. By pressing a selection button 97a of the selection display portion 97, a selection item for the rotor blade to be input corresponding to the periodic inspection results is displayed in the selection display portion 97, which is not illustrated. For example, when the selection item “IP 1st stage blade” is selected in the selection display portion 97, the input screen 90A illustrated in FIG. 4 is displayed on the operation screen of the input device at the manufacturer. At this time, a display information generation section 73 receives information related to the selection of “IP 1 st stage blade” from the input device, and outputs display information for displaying the input screen 90A to the operation screen.

Next, the input screen 90B in FIG. 5 is explained.

Here, when the selection item “HP 1st stage blade” is selected in the selection display portion 97 on the input screen 90A in FIG. 4, the input screen 90B illustrated in FIG. 5 is displayed on the screen of the display part of the user interface 50.
a illustrated on the input screen 90B in FIG. 5 is the erosion depth at the leading edge of the rotor blade, that is, the thinning amount at the leading edge of the rotor blade. a is the distance between the position at the leading edge portion of the rotor blade where thinning has progressed the most in the camber line direction and the leading edge of the new rotor blade at the blade height position at the position where thinning has progressed the most. Incidentally, on the input screen 90B, the blade surface (leading edge portion) of the new rotor blade is illustrated by a dotted line.
b is the erosion depth at a ventral side surface (pressure surface) of the rotor blade, that is, the thinning amount at the ventral side surface of the rotor blade. b is the distance between the position at the leading edge portion of the rotor blade where thinning has progressed the most in a direction perpendicular to the ventral side surface and the ventral side surface of the new rotor blade at the blade height position at the position where thinning has progressed the most.

Incidentally, a and b are values at the position where thinning has progressed the most in the blade height direction. Furthermore, a and b at the rotor blade whose thinning has progressed the most among a plurality of rotor blades planted in the circumferential direction are input. Incidentally, the value of a is used as an initial value when calculating the thinning amount.

Numerical values based on the periodic inspection results are input into numerical value columns 98 and 99 of a and b. Incidentally, an Upload button 94, an All Delete button 95, and a Back button 96 are as described above.

Here, the information related to the latest periodic inspection results becomes, for example, an initial value when arithmetically operating the thinning amount in a fixed-cycle thinning amount arithmetic operation section 71.

Incidentally, although there has been explained one example in which the manufacturer inputs the periodic inspection results here, the present invention may be set so that the user can input the results. In this case, the input screens 90A and 90B illustrated in FIG. 4 and FIG. 5 are displayed on the display part of the user interface 50. When the user inputs the periodic inspection results, the user presses the Upload button 94 after inputting the periodic inspection results. Then, the user interface 50 receives input from the Upload button 94 and outputs information related to the periodic inspection results to the input information storage section 61. The input information storage section 61 receives and stores the information related to the periodic inspection results.

Further, the input information storage section 61 stores an inspection threshold, which is a thinning amount at which the rotor blade should be inspected. Here, it is recommended that the rotor blade whose thinning amount has reached the inspection threshold should be inspected. The inspection threshold is a default value set based on the specifications of the rotor blade or the like, for example. Therefore, the inspection threshold has been stored in the input information storage section 61 in advance. Incidentally, the manufacturer stores the inspection threshold in the input information storage section 61 in advance. Further, for example, the manufacturer can change the inspection threshold in accordance with changes in a management value or the like.

The input information storage section 61 stores a replacement threshold, which is a thinning amount at which the rotor blade should be replaced. Here, it is recommended that the rotor blade whose thinning amount has reached the replacement threshold should be replaced. The replacement threshold is, for example, a default value set based on the thinning amount actually measured during an inspection performed when the thinning amount has reached the inspection threshold and the specifications of the rotor blade. The set replacement threshold is output to the input information storage section 61 from the input device at the manufacturer.

The input information storage section 61 has stored, as an initial value, a preparation period for determining a later-described recommended preparation time, when the thinning amount managing apparatus 18 is installed. The preparation period is a period required to prepare a new rotor blade. Incidentally, the user can change the preparation period from the initial value to a predetermined period by making a request to the manufacturer. In this case, information related to the changed preparation period is output from the input device at the manufacturer to the input information storage section 61 of the thinning amount managing apparatus 18. Then, the input information storage section 61 stores the information related to the changed preparation period.

The measurement data storage section 62 stores the electrical output information and the startup count information output from the measurement data acquisition unit 40. The measurement data storage section 62 stores the electrical output information and the startup count information to be output from the measurement data acquisition unit 40 every hour, for example.

The program storage section 63 stores programs for executing calculations of the thinning amount and the like and management of the thinning amount in the thinning amount managing apparatus 18, as well as various arithmetic expressions/equations, various parameters, and the like for calculating the thinning amount and the like.

The arithmetic operation result storage section 64 stores results arithmetically operated in the arithmetic operation unit 70. The arithmetic operation result storage section 64 stores information on the thinning amount from the past to the present, which is arithmetically operated in the fixed-cycle thinning amount arithmetic operation section 71, for example. Here, the arithmetic operation result storage section 64 stores, for example, arithmetic operation results of the thinning amount from the past to the present, and the like, as the information on the thinning amount from the past to the present. Incidentally, this information functions as past thinning amount related information.

The arithmetic operation result storage section 64 stores information on the future thinning amount arithmetically operated in a future thinning amount arithmetic operation section 72, for example.

The arithmetic operation result storage section 64 stores a recommended inspection time at which the future thinning amount reaches the inspection threshold, which is calculated by the arithmetic operation in the future thinning amount arithmetic operation section 72. Incidentally, the recommended inspection time is specified by year, month, and day. The method of calculating this recommended inspection time will be explained later.

The arithmetic operation result storage section 64 stores a recommended replacement time at which the future thinning amount calculated by the arithmetic operation in the future thinning amount arithmetic operation section 72 reaches the replacement threshold. Incidentally, the recommended replacement time is specified by year, month, and day. The method of calculating the recommended replacement time will be explained later.

Here, the time from the recommended replacement time before a predetermined preparation period is set as the recommended preparation time. The recommended preparation time refers to the time at which it is recommended to start preparation for a new rotor blade for the rotor blade whose recommended replacement time has been specified. Incidentally, the recommended preparation time is also specified by year, month, and day, similarly to the recommended replacement time. For example, when the recommended replacement time is Jun. 1, 2040 and the preparation period is 3 years, the recommended preparation time is Jun. 1, 2037. The preparation period has been stored in the input information storage section 61, as described previously.

Further, the arithmetic operation result storage section 64 stores as a preparation threshold the future thinning amount at the recommended preparation time, which is arithmetically operated by the future thinning amount arithmetic operation section 72. That is, the thinning amount at the recommended preparation time is the preparation threshold. The method of calculating the preparation threshold will be explained later.

The arithmetic operation result storage section 64 stores arithmetic operation results of, for example, the future thinning amount, the preparation threshold, the recommended preparation time, the recommended replacement time, and so on as information on the future thinning amount. Incidentally, these pieces of information function as future thinning amount related information.

The template storage section 65 stores information related to template screens that serve as bases for the screens that display the arithmetic operation results stored in the arithmetic operation result storage section 64. Pieces of information related to various template screens to be displayed on the display part of the user interface 50 have been stored in the template storage section 65 in advance.

The display information storage section 66 stores display information to be displayed on the display part, which is generated in the display information generation section 73 of the arithmetic operation unit 70.

The arithmetic operation unit 70 is an arithmetic operation block including the fixed-cycle thinning amount arithmetic operation section 71, the future thinning amount arithmetic operation section 72, and the display information generation section 73. The arithmetic operation unit 70 reads a program for executing the thinning amount managing apparatus 18 from the program storage section 63 in response to an execution start input by the user from the user interface 50. This makes it possible to execute the functions of the fixed-cycle thinning amount arithmetic operation section 71, the future thinning amount arithmetic operation section 72, and the display information generation section 73.

The fixed-cycle thinning amount arithmetic operation section 71 is an arithmetic operation block that reads arithmetic expressions/equations and parameters for calculating the thinning amount from the program storage section 63 and calculates the amount of thinning caused by SPE in a fixed-cycle based on the electrical output information and the startup count information stored in the measurement data storage section 62. The fixed-cycle thinning amount arithmetic operation section 71 outputs information related to the calculated thinning amount to the arithmetic operation result storage section 64. Incidentally, the fixed-cycle thinning amount arithmetic operation section 71 may obtain the startup count information from the electrical output information.

Here, the fixed-cycle refers to, for example, a one-hour cycle from a predetermined date in the past to the present. The fixed-cycle thinning amount arithmetic operation section 71 calculates the thinning amount every fixed-cycle (for example, every hour) based on the electrical output information and the startup count information, while using the thinning amount measured during a periodic inspection on a predetermined date in the past as an initial value. Then, the thinning amount at the present is calculated by adding the thinning amount that has progressed from a predetermined date in the past to the present to the thinning amount measured during the periodic inspection on the predetermined date in the past. Incidentally, the thinning amount that has progressed from the predetermined date in the past to the present, which is calculated by the fixed-cycle thinning amount arithmetic operation section 71, is a predicted value.

The fixed-cycle thinning amount arithmetic operation section 71 determines whether or not the calculated thinning amount has reached the inspection threshold based on the inspection threshold stored in the input information storage section 61.

The fixed-cycle thinning amount arithmetic operation section 71 determines whether or not the calculated thinning amount has reached the replacement threshold based on the replacement threshold stored in the input information storage section 61. Further, the fixed-cycle thinning amount arithmetic operation section 71 determines whether or not the calculated thinning amount has reached the preparation threshold based on the preparation threshold stored in the input information storage section 61. Incidentally, the operations related to these determinations in the fixed-cycle thinning amount arithmetic operation section 71 will be described later.

The future thinning amount arithmetic operation section 72 is an arithmetic operation block that reads arithmetic expressions/equations and parameters for calculating the thinning amount from the program storage section 63 and calculates the amount of thinning caused by SPE in the future based on the future operating conditions stored in the input information storage section 61. The future thinning amount arithmetic operation section 72 outputs information related to the calculated thinning amount to the arithmetic operation result storage section 64.

Here, the future refers to the period from the present to a year in the future set as the future operating condition. The future thinning amount arithmetic operation section 72 calculates the future thinning amount every predetermined year (for example, every year) based on the future operating condition stored in the input information storage section 61, while using the present thinning amount calculated in the fixed-cycle thinning amount arithmetic operation section 71 as an initial value. Incidentally, the future thinning amount calculated by the future thinning amount arithmetic operation section 72 is a predicted value.

The future thinning amount arithmetic operation section 72 determines whether or not the future thinning amount has reached the inspection threshold based on the inspection threshold stored in the input information storage section 61 and the calculated future thinning amount. When determining that the future thinning amount has reached the inspection threshold, the future thinning amount arithmetic operation section 72 calculates the recommended inspection time at which the future thinning amount reaches the inspection threshold.

Further, the future thinning amount arithmetic operation section 72 determines whether or not the future thinning amount has reached the replacement threshold based on the replacement threshold stored in the input information storage section 61 and the calculated future thinning amount. When determining that the future thinning amount has reached the replacement threshold, the future thinning amount arithmetic operation section 72 calculates the recommended replacement time at which the future thinning amount reaches the replacement threshold.

Furthermore, when determining that the future thinning amount has reached the replacement threshold, the future thinning amount arithmetic operation section 72 calculates the recommended preparation time and the preparation threshold based on the preparation period described previously.

Here, for convenience of explanation, the thinning amount from the past to the present arithmetically operated by the fixed-cycle thinning amount arithmetic operation section 71 is referred to as a past thinning amount, and the thinning amount from the present to a predetermined date in the future arithmetically operated by the future thinning amount arithmetic operation section 72 is referred to as a future thinning amount.

The display information generation section 73 is an arithmetic operation block that generates display information to be displayed on the display part of the user interface 50. The display information generation section 73 generates display information based on the information stored in the arithmetic operation result storage section 64 and the template storage section 65. Incidentally, the display information generation section 73 may directly receive the arithmetic operation results of the fixed-cycle thinning amount arithmetic operation section 71 and the future thinning amount arithmetic operation section 72 and generate the display information based on the information stored in the template storage section 65, for example.

The display information generation section 73 outputs the generated display information to the display information storage section 66. Further, the display information storage section 73 outputs the generated display information to the user interface 50.

Here, the thinning amount managing apparatus 18 described above can be configured by a computer device or the like, which includes an arithmetic device such as a CPU (Central Processing Unit), a storage device such as a ROM (Read Only Memory) or RAM (Random Access Memory), an external storage device such as a HDD (Hard Disk Drive) or CD (Compact Disc) drive device, a display device such as a display, an input device such as a keyboard or a mouse, and so on.

### (Arithmetic Operations in the Fixed-Cycle Thinning Amount Arithmetic Operation Section 71 and the Future Thinning Amount Arithmetic Operation Section 72)

Here, the flows of arithmetic operations in the fixed-cycle thinning amount arithmetic operation section 71 and the future thinning amount arithmetic operation section 72 are explained.

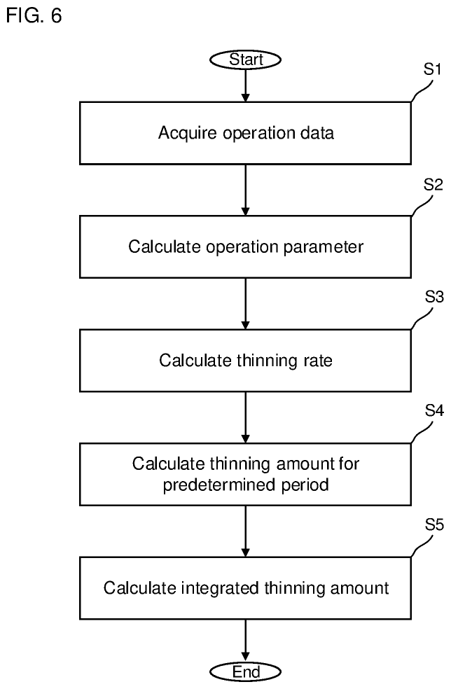

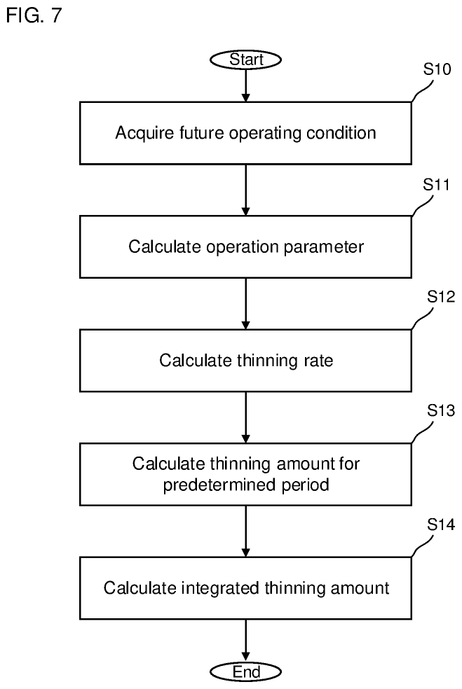

FIG. 6 is a flowchart for explaining the flow of arithmetic operation of the past thinning amount in the fixed-cycle thinning amount arithmetic operation section 71 of the thinning amount managing apparatus 18 in the first embodiment. FIG. 7 is a flowchart for explaining the flow of arithmetic operation of the future thinning amount in the future thinning amount arithmetic operation section 72 of the thinning amount managing apparatus 18 in the first embodiment.

First, referring to FIG. 6, the flow of the arithmetic operation of the past thinning amount in the fixed-cycle thinning amount arithmetic operation section 71 is explained.

As illustrated in FIG. 6, the fixed-cycle thinning amount arithmetic operation section 71 reads, as the operation data, the electrical output information and the startup count information from the measurement data storage section 62 (Step S1). Here, the electrical output information related to the output of the generator and the startup count information related to the startup count of the steam turbine function as measured information for arithmetically operating the past thinning amount. Incidentally, when executing Step S1, the fixed-cycle thinning amount arithmetic operation section 71 has already read the program for executing the arithmetic operation of the past thinning amount and the arithmetic expressions/equations and parameters for calculating the past thinning amount from the program storage section 63, the design information of the rotor blade to be managed from the input information storage section 61, and so on. Incidentally, the fixed-cycle thinning amount arithmetic operation section 71 may obtain the information related to the startup count based on the electrical output information.

Then, the fixed-cycle thinning amount arithmetic operation section 71 calculates an operation parameter based on the electrical output information and the startup count information (Step S2). The fixed-cycle thinning amount arithmetic operation section 71 calculates a startup frequency F, which is the startup count per operating time T, by Equation (1). Incidentally, T is a proportional constant term related to the operating time.

$$F = T \times ( \frac{N}{t} ) \qquad ( 1 )$$

Here, N is the startup count of the steam turbine including the rotor blade to be managed, and t is the operating time (hour) of the steam turbine. Incidentally, when the steam turbine is started a plurality of times, the operating time results in the time obtained by integrating the operating time related to each startup. The fixed-cycle thinning amount arithmetic operation section 71 calculates the operating time based on the electrical output information.

Here, the startup count is the startup count related to all or each of the startups of cold startup, warm startup, and hot startup. The operating time is the time obtained by integrating the operating time related to all or each of the cold startup, the warm startup, and the hot startup. The startup count and the operating time may be used differently depending on whether the steam turbine is the intermediate-pressure turbine 13 or the high-pressure turbine 11.

Then, the fixed-cycle thinning amount arithmetic operation section 71 calculates a thinning rate as described below (Step S3). Here, the fixed-cycle thinning amount arithmetic operation section 71 calculates the thinning rate by reading the probability distribution formula for the time of the thinning amount to reach a management value as the probability distribution formula for the average thinning rate, according to the operation parameter and a design parameter.

Here, a survival function, namely, the probability that the thinning amount at a certain time does not reach the management value, is expressed by Equation (2). S₀(t) is a reference survival function when using a Cox proportional hazard model, and is defined as a survival function when Xi to be described later is all zero, that is, Ci=1 is established.

$$S ( t ) = {{S}_{0} ( t )}^{C i} \qquad ( 2 )$$

Here, t is an operating time. Ci is an equation that determines the degree of influence of a parameter that affects thinning, and is expressed by Equation (3). Incidentally, as i in Equation (3), any numerical value of 1 or more can be set.

$$\begin{matrix}Ci = EXP [ \sum ( βi \times X i ) ] & ( i = 1 - n )\end{matrix} \qquad ( 3 )$$

Xi is a constant or variable regarding operating conditions, design conditions, or the like related to the factor of thinning. Here, Xi includes, for example, the startup frequency F. βi is a value that determines the degree of influence on the above-described thinning factor Xi, and is a coefficient that is individually set for each Xi. Here, βi includes, for example, the degree of influence of the startup frequency F. Incidentally, the information related to Xi and βi described above has been stored in the input information storage section 61.

As described above, the probability that the thinning amount does not reach the management value at a certain time is expressed by Equation (2). Here, by solving Equation (2) for t and dividing the management value by t, a relational expression between the probability that the thinning amount does not reach the management value and an average thinning rate v can be obtained.

Here, in Equation (2), t when S(t)=P is established is set to tₚ. P is the survival probability of the thinning amount related to the thinning rate, and has been stored in the input information storage section 61.

For example, when the average thinning rate v at the survival probability P is set to vₚ, vₚ is calculated by dividing the management value by tₚ. Strictly speaking, this means that the thinning rate of a surviving rotor blade during the operating time tₚ is slower than the average thinning rate vₚ found here. Here, the relational expression between the probability that the thinning amount does not reach the management value and the average thinning rate v, which is described previously, can be read as the probability distribution formula of the average thinning rate until the thinning amount reaches the management value.

Then, the fixed-cycle thinning amount arithmetic operation section 71 calculates the thinning rate V from the probability distribution formula of the average thinning rate until the thinning amount reaches the management value.

Incidentally, the above-described arithmetic operation is one example, and the present invention is not limited to this.

Then, the fixed-cycle thinning amount arithmetic operation section 71 calculates the thinning amount during a predetermined period as described below (Step S4). When the operating time during the predetermined period is set to Δt, a thinning amount ΔD during the predetermined period is expressed by Equation (4).

$$Δ D = V \times Δ t \qquad ( 4 )$$

The fixed-cycle thinning amount arithmetic operation section 71 calculates the thinning amount ΔD during the predetermined period based on Equation (4) and the thinning rate V.

Then, the fixed-cycle thinning amount arithmetic operation section 71 calculates the integrated thinning amount as described below (Step S5). The integrated thinning amount is expressed by Equation (5).

$$Thinning amount = \sum Δ D \qquad ( 5 )$$

The fixed-cycle thinning amount arithmetic operation section 71 calculates the integrated thinning amount by integrating the thinning amount ΔD during each predetermined period using Equation (5).

As above, the fixed-cycle thinning amount arithmetic operation section 71 calculates the past thinning amount by adding the thinning amount measured during a periodic inspection on a predetermined date in the past to the integrated thinning amount calculated by the above-described arithmetic operation. As a result, the past thinning amount at the first-stage rotor blade that has reflected the operation of the high-pressure turbine 11 or the intermediate-pressure turbine 13 can be obtained.

Incidentally, the fixed-cycle thinning amount arithmetic operation section 71 outputs the arithmetic operation result to the arithmetic operation result storage section 64. The arithmetic operation of the past thinning amount in the fixed-cycle thinning amount arithmetic operation section 71 described above is executed every hour, for example. The most recently calculated past thinning amount corresponds to the present thinning amount.

Next, referring to FIG. 7, the flow of the arithmetic operation of the future thinning amount in the future thinning amount arithmetic operation section 72 is explained.

The arithmetic operation flow of the future thinning amount arithmetic operation section 72 is basically the same as that of the fixed-cycle thinning amount arithmetic operation section 71 except for Step S10 and Step S11 illustrated in FIG. 7. That is, pieces of the processing at Step S12 to Step S14 in the arithmetic operation by the future thinning amount arithmetic operation section 72 are basically the same as those at Step S3 to Step S5 in the arithmetic operation by the fixed-cycle thinning amount arithmetic operation section 71. Therefore, pieces of the processing at Step S10 and Step S11 in the arithmetic operation by the future thinning amount arithmetic operation section 72 are mainly explained.

As illustrated in FIG. 7, the future thinning amount arithmetic operation section 72 reads the future operating condition from the input information storage section 61 (Step S10). Incidentally, when executing Step S10, the future thinning amount arithmetic operation section 72 has already read the program for executing the arithmetic operation of the future thinning amount and the arithmetic expressions/equations and parameters for calculating the future thinning amount from the program storage section 63, the design information of the rotor blade to be managed from the input information storage section 61, and so on.

Then, the future thinning amount arithmetic operation section 72 reads the startup count information in the column of Start Up Plan 89 and information related to the availability factor (availability factor information) from the input information storage section 61 based on the future operating condition (Step S10). The availability factor information is obtained based on operation data in a predetermined year in the case of the past operation performance mode 82, preset information in the case of the base load operation mode 83 and the peak load operation mode 84, and Operation Data 86 in the case of the detailed operation setting mode 85. Incidentally, in this arithmetic operation, the startup count information read from the input information storage section 61 is handled in the same way as the startup count information read from the measurement data storage section 62 in the previously-described arithmetic operation by the fixed-cycle thinning amount arithmetic operation section 71.

Then, the future thinning amount arithmetic operation section 72 calculates the operation parameter based on the startup count information and the availability factor information (Step S11). The future thinning amount arithmetic operation section 72 calculates the startup frequency F, which is the startup count per operating time T, by Equation (1) described previously. At this time, the future thinning amount arithmetic operation section 72 calculates t, which is the operating time of the steam turbine including the rotor blade to be managed, based on the availability factor information.

Then, the future thinning amount arithmetic operation section 72 executes pieces of the processing at Step S12 to Step S14 and calculates the integrated thinning amount that will progress from the present to a predetermined date in the future.

Then, the future thinning amount arithmetic operation section 72 calculates the future thinning amount on a predetermined date in the future by adding the most recent past thinning amount calculated by the fixed-cycle thinning amount arithmetic operation section 71 to the calculated thinning amount that will progress from the present to a predetermined date in the future. As a result, the future thinning amount at the first-stage rotor blade that has reflected the operation in the high-pressure turbine 11 or the intermediate-pressure turbine 13 can be obtained.

Incidentally, the future thinning amount arithmetic operation section 72 outputs the arithmetic operation result to the arithmetic operation result storage section 64. The arithmetic operation result of the future thinning amount in the future thinning amount arithmetic operation section 72 described above is obtained for each one-year cycle set as the future operating condition. That is, the arithmetic operation result in the future thinning amount arithmetic operation section 72 is obtained in units of one year.

### (Calculations of the Recommended Inspection Time, the Recommended Replacement Time, the Recommended Preparation Time, and the Preparation Threshold)

Here, the method of calculating the recommended inspection time, the recommended replacement time, the recommended preparation time, and the preparation threshold is explained. Incidentally, the explanation is made here based on the assumption that the replacement threshold has been set based on the thinning amount actually measured during an inspection performed when the thinning amount has reached the inspection threshold and the specifications of the rotor blade. Further, there is explained, as an example, the case where the preparation period is set to 3 years here.

Incidentally, the recommended replacement time and the recommended inspection time are calculated using the same method basically, and thus, the method of calculating the recommended replacement time is explained as an example here.

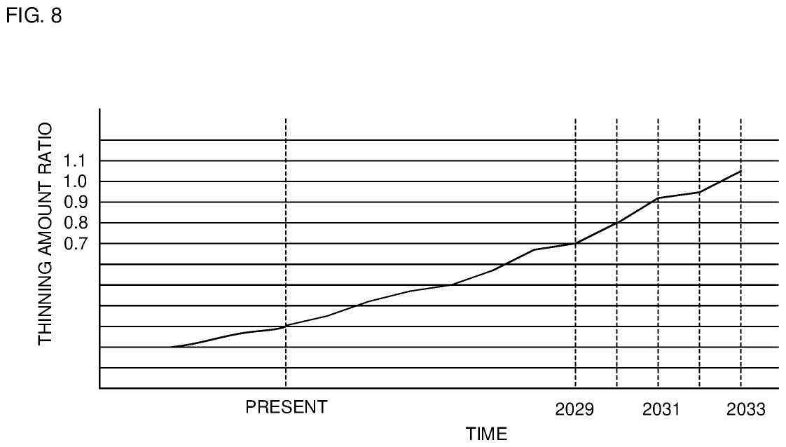

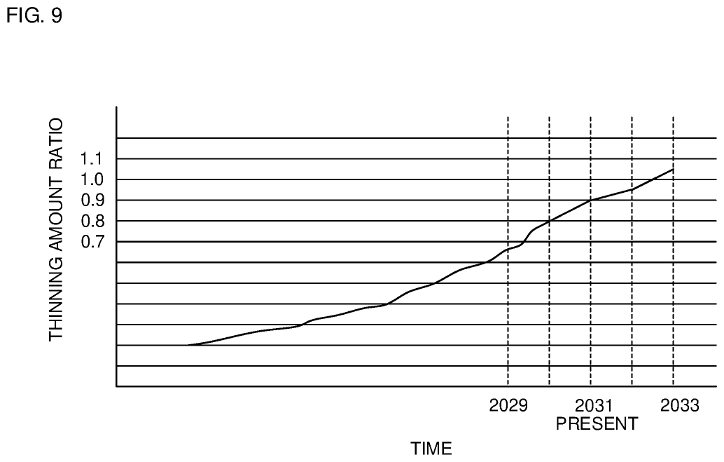

FIG. 8 and FIG. 9 are views for explaining the method of calculating the recommended inspection time, the recommended replacement time, the recommended preparation time, and the preparation threshold in the future thinning amount arithmetic operation section 72 of the thinning amount managing apparatus 18 in the first embodiment. In FIG. 8 and FIG. 9, the horizontal axis indicates a time (year), and the vertical axis indicates a thinning amount ratio. Incidentally, the assumed month and day in each year on the horizontal axis is January 1 here.

Here, the thinning amount is described as a thinning amount ratio. The thinning amount ratio here is exemplified by the thinning amount ratio when the thinning amount at the replacement threshold is set to 1. Incidentally, although there is explained one example here in which the thinning amount at the replacement threshold is 1, that is, the reference, the present invention is not limited to this. For example, the thinning amount at the replacement threshold may be explained by setting the thinning amount at the inspection threshold to 1 (reference). When the thinning amount ratio is smaller than 1.0, the thinning amount is below the replacement threshold. When the thinning amount ratio is larger than 1.0, the thinning amount exceeds the replacement threshold.

First, referring to FIG. 8, there is explained the case where the time when the thinning amount reaches the preparation threshold is the future.

As illustrated in FIG. 8, the thinning amount ratio in year 2032 is smaller than 1.0, and the thinning amount ratio in year 2033 is larger than 1.0. Therefore, the thinning amount ratio reaches 1.0 during the period between year 2032 and year 2033. That is, the recommended replacement time exists during the period between year 2032 and year 2033.

The future thinning amount arithmetic operation section 72 expresses the relationship between a time and a thinning amount ratio as a linear function during the period between year 2032 and year 2033. Then, the future thinning amount arithmetic operation section 72 calculates the month and day when the thinning amount ratio becomes 1.0.

In the example illustrated in FIG. 8, the thinning amount ratio in year 2032 is 0.95, and the thinning amount ratio in year 2033 is 1.05. The future thinning amount arithmetic operation section 72 calculates the recommended replacement time when the thinning amount ratio becomes 1.0 based on the linear function. In the example illustrated in FIG. 8, as a result of the arithmetic operation, Jul. 1, 2032 is the recommended replacement time.

Then, the future thinning amount arithmetic operation section 72 calculates the recommended preparation time based on the recommended replacement time and the preparation period. Here, when the preparation period is set to 3 years, the recommended preparation time is Jul. 1, 2029, which is 3 years before the recommended replacement time.

Then, the future thinning amount arithmetic operation section 72 expresses the relationship between a time and a thinning amount ratio as a linear function during the period between year 2029 and year 2030. Then, the future thinning amount arithmetic operation section 72 calculates the thinning amount ratio on Jul. 1, 2029. In the example illustrated in FIG. 8, as a result of the arithmetic operation, the thinning amount ratio on Jul. 1, 2029 is 0.75. This result reveals that the preparation threshold, which is the thinning amount ratio at the recommended preparation time, is 0.75.

Then, the future thinning amount arithmetic operation section 72 outputs the above-described arithmetic operation results of the recommended replacement time, the recommended preparation time, and the preparation threshold to the arithmetic operation result storage section 64. The arithmetic operation result storage section 64 receives and stores the arithmetic operation results of the recommended replacement time, the recommended preparation time, and the preparation threshold.

Next, referring to FIG. 9, there is explained the case where the time when the thinning amount reaches the preparation threshold is the past.

As illustrated in FIG. 9, the thinning amount ratio reaches 1.0 during the period between year 2032 and year 2033. That is, the recommended replacement time exists during the period between year 2032 and year 2033. Therefore, the recommended preparation time exists in the past rather than at present (year 2031).

As illustrated in FIG. 9, as in the explanation with reference to FIG. 8, the future thinning amount arithmetic operation section 72 calculates the month and day when the thinning amount ratio is 1.0 by expressing the relationship between a time and a thinning amount ratio as a linear function during the period between year 2032 and year 2033. In the example illustrated in FIG. 9, as a result of the arithmetic operation, Jul. 1, 2032 is the recommended replacement time.

Then, the future thinning amount arithmetic operation section 72 calculates the recommended preparation time based on the recommended replacement time and the preparation period. Here, when the preparation period is set to 3 years, the recommended preparation time is Jul. 1, 2029, which is 3 years before the recommended replacement time.

Then, the future thinning amount arithmetic operation section 72 reads the thinning amount on Jul. 1, 2029 from the arithmetic operation result storage section 64 and calculates the thinning amount ratio. This calculated thinning amount ratio is the preparation threshold.

Here, the thinning amount on Jul. 1, 2029 is the result of the arithmetic operation by the fixed-cycle thinning amount arithmetic operation section 71. Therefore, the arithmetic operation result storage section 64 has stored a plurality of data every hour as the arithmetic operation result for this day. Thus, as the thinning amount on Jul. 1, 2029, the future thinning amount arithmetic operation section 72 refers to the largest thinning amount in pieces of the data of the thinning amount on Jul. 1, 2029, for example.

Then, the future thinning amount arithmetic operation section 72 outputs the above-described arithmetic operation results of the recommended replacement time, the recommended preparation time, and the preparation threshold to the arithmetic operation result storage section 64. The arithmetic operation result storage section 64 receives and stores the arithmetic operation results of the recommended replacement time, the recommended preparation time, and the preparation threshold.

Here, as a result of the arithmetic operation of the future thinning amount, when the thinning amount ratio does not reach 1.0 during a specified future arithmetic operation period, the recommended replacement time, the recommended preparation time, and the preparation threshold are not obtained.

### (Regarding the Thinning Amount Managing Apparatus 18 at the Time of Installation)

Here, the state of the thinning amount managing apparatus 18 at the time of installation is first explained.

At the time of installation of the thinning amount managing apparatus 18, the display information storage section 66 has stored display information on the past thinning amount and the future thinning amount as of the date of installation. That is, at the time of installation, the thinning amount managing apparatus 18 is in a state of being capable of displaying the past thinning amount and the future thinning amount as of the date of installation on the display part of the user interface 50.

That is, the display information storage section 66 has stored the display information as of the date of installation generated by the display information generation section 73 based on the arithmetic operation results obtained by arithmetic operations by the fixed-cycle thinning amount arithmetic operation section 71 and the future thinning amount arithmetic operation section 72 stored in the arithmetic operation result storage section 64 and the information related to the template screens stored in the template storage section 65.

Incidentally, the manufacturer has processed the thinning amount managing apparatus 18 so as to bring it into the above-described state as of the date of installation.

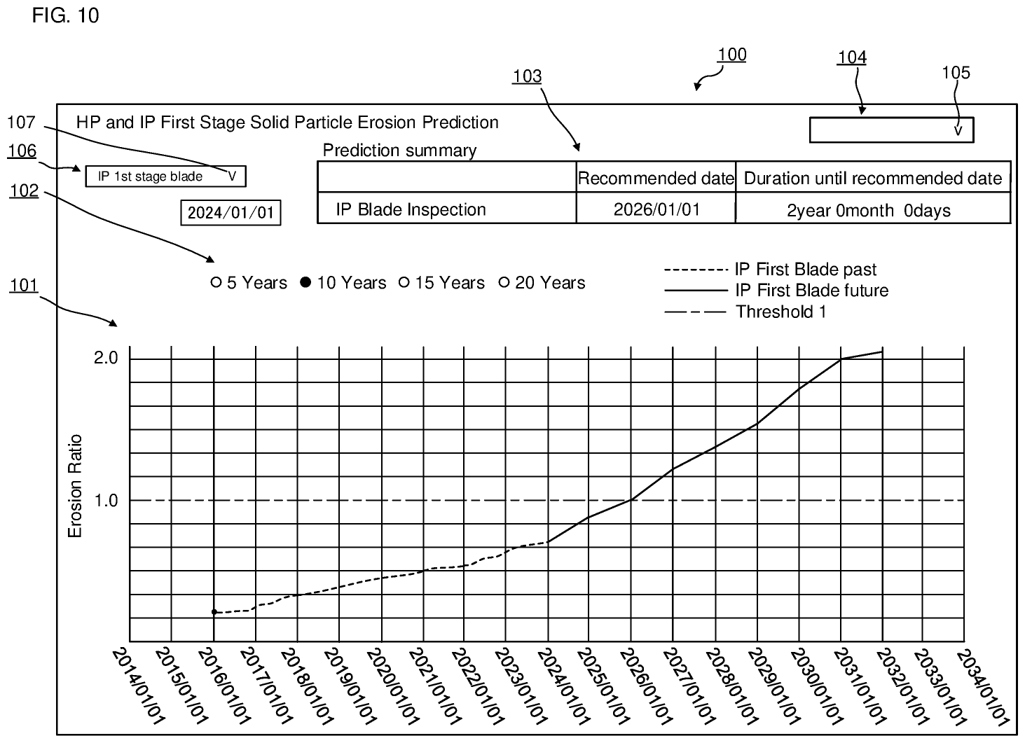

Here, FIG. 10 is a view illustrating one example of the display screen 100 on which the display information was displayed as of the date of installation of the thinning amount managing apparatus 18 in the first embodiment. Here, there is explained one example of the thinning amount related information at the first-stage rotor blade of the intermediate-pressure turbine 13. By pressing a selection button 107 in a selection display portion 104 on the display screen 100 illustrated in FIG. 10, a rotor blade selection item is displayed in the selection display portion 106. Then, when the selection item “IP 1st stage blade” is selected, the display screen 100 illustrated in FIG. 10 is displayed on the screen of the display part of the user interface 50. Incidentally, the same display screen is also displayed on the display screen that displays thinning amount related information at the first-stage rotor blade of the high-pressure turbine 11.

As illustrated in FIG. 10, on the display screen 100, the result of the past thinning amount arithmetically operated by the fixed-cycle thinning amount arithmetic operation section 71 (dotted line) and the result of the future thinning amount arithmetically operated by the future thinning amount arithmetic operation section 72 (solid line) have been illustrated in chronological order. In a graph 101 illustrating the results of these thinning amounts, the horizontal axis indicates year, month, and day, and the vertical axis indicates a thinning amount ratio. Incidentally, Jan. 1, 2024 is set as the present here. Further, in the graph 101, the thinning amount is illustrated as the thinning amount ratio. The thinning amount ratio here is exemplified by the thinning amount ratio when the thinning amount at the inspection threshold is set to 1. Incidentally, the thinning amount ratio illustrated on the display screen 100 below is exemplified by the thinning amount ratio when the thinning amount at the inspection threshold is set to 1.

FIG. 10 illustrates a time axis from Jan. 1, 2014 to Jan. 1, 2034. The range of this time axis is set by selecting a set value of a time axis setting portion 102 on the display screen 100. There is illustrated one example here in which 5 years, 10 years, years, and 20 years are set as the set value of the time axis setting portion 102. Incidentally, in FIG. 10, the set value of 10 years has been selected.

The time axis indicates the past for the set value from the present and the future for the set value from the present. For example, when the set value of 10 years is selected as illustrated in FIG. 10, the time range for the past 10 years from the present (Jan. 1, 2024) to Jan. 1, 2014 and the time range for the future 10 years from the present (Jan. 1, 2024) to Jan. 1, 2034 are displayed as the time axis.

Thus, the user can arbitrarily change the range of the time axis by selecting the set value in the time axis setting portion 102.

Incidentally, in FIG. 10, the arithmetic operation results from Jan. 1, 2016 to Jan. 1, 2032 have been illustrated as the thinning amount. In this case, the thinning amount ratios from Jan. 1, 2016 to Jan. 1, 2024 are the thinning amount ratio based on the past thinning amount, and the thinning amount ratios from Jan. 1, 2024 to Jan. 1, 2032 are the thinning amount ratio based on the future thinning amount.

Here, the thinning amount ratio on Jan. 1, 2016 has been illustrated based on the periodic inspection results input from the input screen 90A illustrated in FIG. 4. In the graph 101 on the display screen 100, the thinning amount ratio based on the periodic inspection results has been illustrated by a black circle. Incidentally, even in the case where there are arithmetic operation results prior to the latest periodic inspection, for example, the arithmetic operation results of and after the latest periodic inspection are displayed on the display screen 100, and the arithmetic operation results prior to the latest periodic inspection are not displayed.

Further, on the display screen 100, the inspection threshold has been illustrated as “Threshold 1” by a dot and dash line. An alarm display 103 is displayed on the display screen 100. The alarm display 103 is displayed, for example, when the future thinning amount or the past thinning amount exceeds the inspection threshold. Incidentally, the inspection threshold is a default value stored in the input information storage section 61 as an initial value, and thus, “Threshold 1” has always been displayed on the display screen 100.

In the arithmetic operation results illustrated in FIG. 10, the future thinning amount has reached the inspection threshold, and thus, the recommended inspection time has been illustrated as the alarm display 103. Further, in FIG. 10, there has been illustrated one example of the alarm display 103 displaying the year, month, and day from the present until the recommended inspection time.

As illustrated in FIG. 10, on the display screen 100 of the user interface 50, variations in the past thinning amount and the future thinning amount over time are displayed on the single graph 101. Further, when the future thinning amount exceeds the inspection threshold, the recommended inspection time is displayed on the display screen 100.

### (Fixed-Cycle Thinning Amount Arithmetic Operation Processing)

Next, there is explained fixed-cycle thinning amount arithmetic operation processing in the thinning amount managing apparatus 18 in the first embodiment. Incidentally, the explanation is made here based on the assumption that the thinning amount has not reached the inspection threshold when the thinning amount managing apparatus 18 is installed.

The fixed-cycle thinning amount arithmetic operation processing will be explained separately into pre-inspection arithmetic operation processing, which is before the inspection performed based on the fact that the thinning amount has reached the inspection threshold, and post-inspection arithmetic operation processing, which is after the inspection performed based on the fact that the thinning amount has reached the inspection threshold.

First, the pre-inspection arithmetic operation processing is explained.

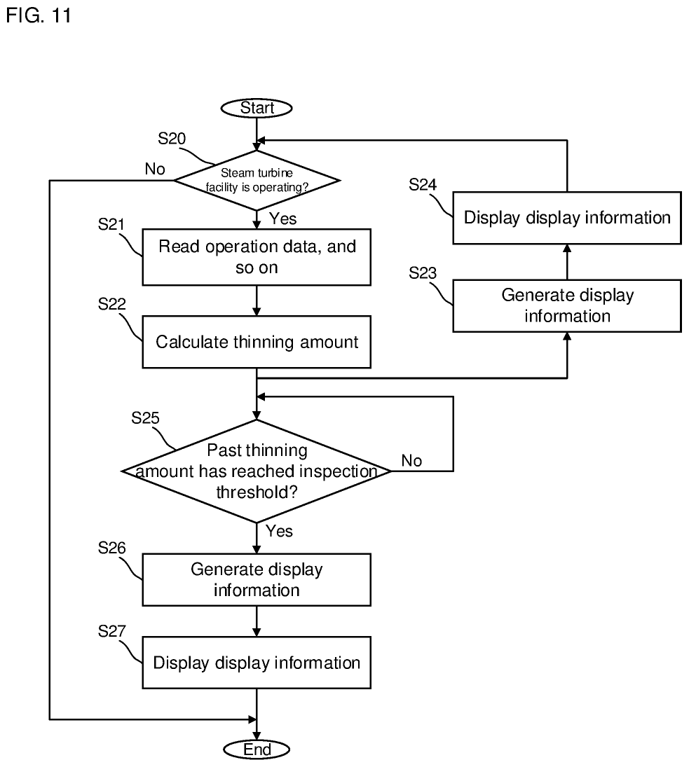

FIG. 11 is a flowchart for explaining a method of the fixed-cycle thinning amount arithmetic operation processing in the thinning amount managing apparatus 18 in the first embodiment.

As illustrated in FIG. 11, the fixed-cycle thinning amount arithmetic operation section 71 determines whether or not the steam turbine facility 1 is operating based on the information stored in the measurement data storage section 62, for example (Step S20). The fixed-cycle thinning amount arithmetic operation section 71 determines whether or not the steam turbine facility 1 is operating based on, for example, the electrical output information.

When determining in the determination of Step S20 that the steam turbine facility 1 is not operating (No at Step S20), the fixed-cycle thinning amount arithmetic operation section 71 finishes the fixed-cycle thinning amount arithmetic operation processing.

When determining in the determination of Step S20 that the steam turbine facility 1 is operating (Yes at Step S20), the fixed-cycle thinning amount arithmetic operation section 71 reads the program for executing the arithmetic operation of the past thinning amount and the arithmetic expressions/equations and parameters for calculating the past thinning amount from the program storage section 63, the design information of the rotor blade to be managed from the input information storage section 61, and the startup count information and the electrical output information stored in the measurement data storage section 62 (Step S21).

Then, the fixed-cycle thinning amount arithmetic operation section 71 arithmetically operates the past thinning amount using the arithmetic operation method explained with reference to FIG. 6, and outputs the arithmetic operation result to the arithmetic operation result storage section 64 (Step S22). The arithmetic operation result storage section 64 stores the arithmetic operation result.

The display information generation section 73 generates display information based on the arithmetic operation result stored in the arithmetic operation result storage section 64 and the information stored in the template storage section 65 (Step S23). Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 10 (Step S24).

Here, the display information generation section 73 outputs the display information based on the arithmetic operation result to the display information storage section 66 and the user interface 50 every hour. Therefore, the graph 101 illustrating the arithmetic operation result regarding the past thinning amount displayed on the display part is updated every hour. For example, after arithmetically operating the past thinning amount, the fixed-cycle thinning amount arithmetic operation section 71 performs pieces of the processing at Step S20 to Step S24 repeatedly every hour.

Further, after the processing at Step S22, the fixed-cycle thinning amount arithmetic operation section 71 determines whether or not the past thinning amount has reached the inspection threshold based on the arithmetic operation result (Step S25).

When determining in the determination of Step S25 that the past thinning amount has not reached the inspection threshold (No at Step S25), the fixed-cycle thinning amount arithmetic operation section 71 executes the processing at Step S25 again.

When determining in the determination of Step S25 that the past thinning amount has reached the inspection threshold (Yes at Step S25), the fixed-cycle thinning amount arithmetic operation section 71 outputs information on the year, month, and day when the past thinning amount reached the inspection threshold (information related to the recommended inspection time) to the arithmetic operation result storage section 64. The arithmetic operation result storage section 64 stores this information.

The display information generation section 73 generates display information based on the arithmetic operation result stored in the arithmetic operation result storage section 64 and the information stored in the template storage section 65 (Step S26). Then, the display information generation section 73 outputs the generated display information to the display information storage section 66 and the user interface 50. The display information storage section 66 stores the display information.

The user interface 50 updates the display screen based on the display information output from the display information generation section 73 (Step S27).

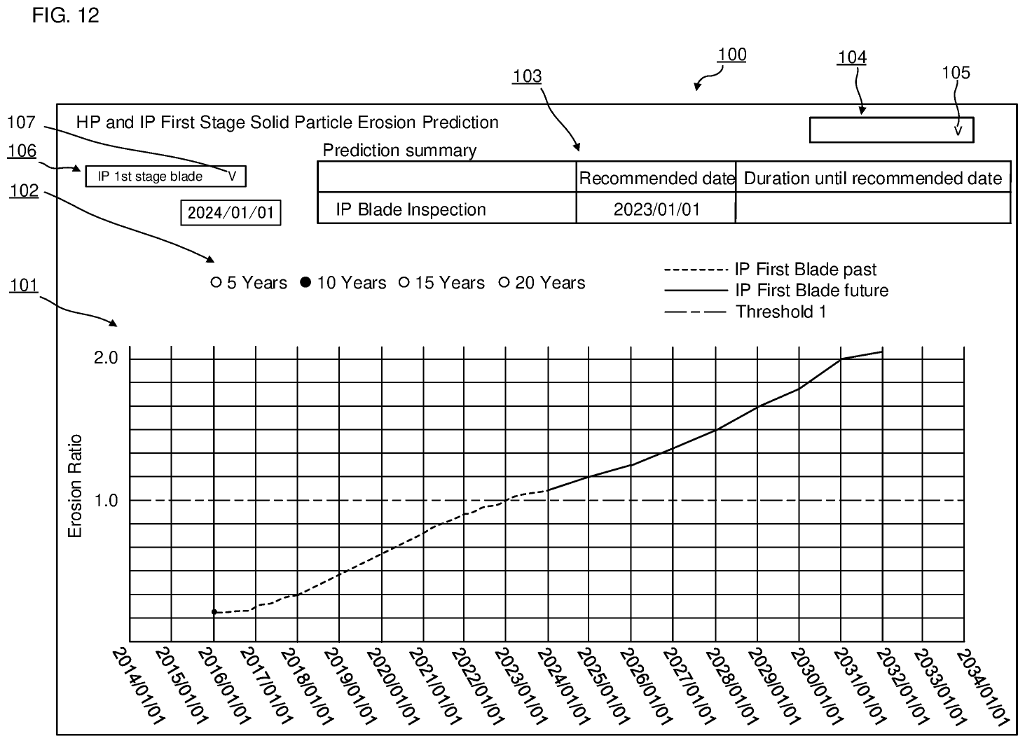

Here, FIG. 12 is a view illustrating one example of the display screen 100 on which arithmetic operation results have been displayed in the thinning amount managing apparatus 18 in the first embodiment. FIG. 12 illustrates the display screen 100 on which arithmetic operation results from the day when the past thinning amount reached the inspection threshold until immediately before the operation of the steam turbine facility 1 is stopped in order to perform inspection have been displayed. As illustrated in FIG. 12, the information on the recommended inspection time is displayed on the alarm display 103. Incidentally, in the arithmetic operation results illustrated in FIG. 12, the replacement threshold has not been set because it is before inspection. Here, there has been explained one example of the thinning amount related information at the first-stage rotor blade of the intermediate-pressure turbine 13. Incidentally, the same display screen is also displayed on the display screen that displays thinning amount related information at the first-stage rotor blade of the high-pressure turbine 11.

Next, the post-inspection arithmetic operation processing is explained.

Here, when executing the post-inspection arithmetic operation processing, the replacement threshold has been set based on the measurement of the thinning amount at the time of inspection. Then, the replacement threshold has been input by the manufacturer and stored in the input information storage section 61. Here, there has been explained one example in which the thinning amount at the replacement threshold is set to twice the thinning amount at the inspection threshold. Incidentally, even in the case where the actually measured thinning amount at the time of inspection has not reached the inspection threshold, the replacement threshold is set based on the actually measured thinning amount when the thinning amount predicted by arithmetic operation has reached the inspection threshold. Then, even in the case where the actually measured thinning amount at the time of inspection has not reached the inspection threshold, in the post-inspection arithmetic operation processing, the determination based on the inspection threshold is not made for the arithmetically operated thinning amount.

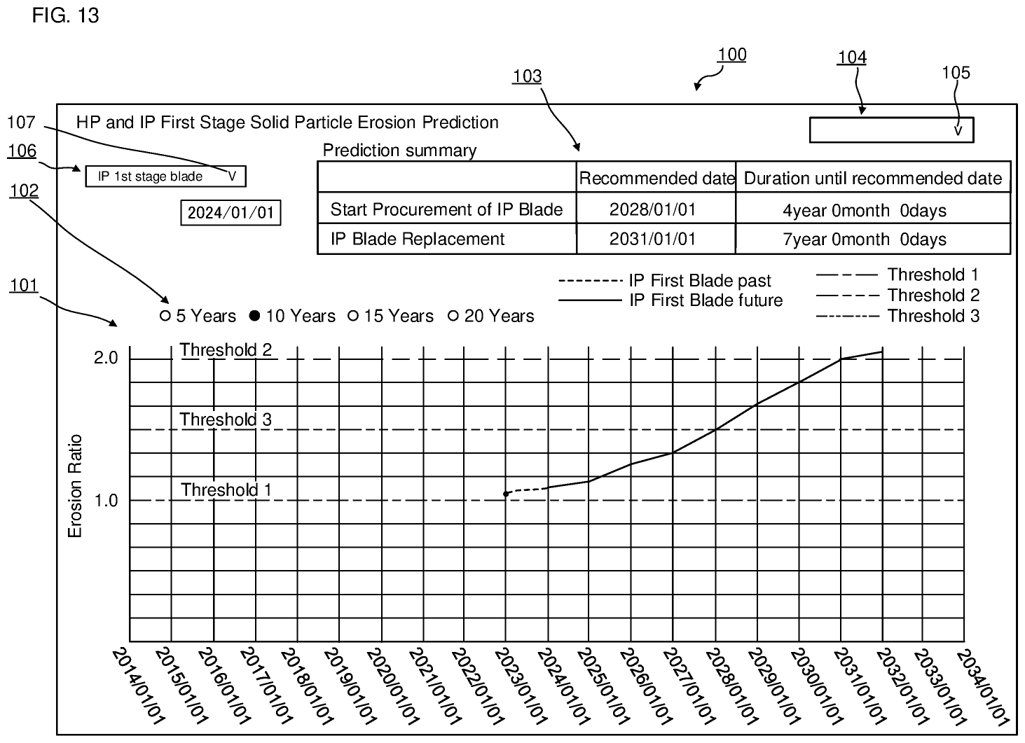

FIG. 13 is a view illustrating one example of the display screen 100 displaying the arithmetic operation results in the post-inspection arithmetic operation processing in the thinning amount managing apparatus 18 in the first embodiment. FIG. 13 illustrates one example in which the arithmetically operated future thinning amount reaches the replacement threshold. Therefore, the future thinning amount arithmetic operation section 72 arithmetically operates the recommended replacement time, the preparation threshold, and the recommended preparation time based on the day when the future thinning amount reaches the replacement threshold and outputs the arithmetic operation results to the arithmetic operation result storage section 64. Thereby, the arithmetic operation result storage section 64 has stored the recommended replacement time, the preparation threshold, and the recommended preparation time. Incidentally, the method of calculating the recommended replacement time, the preparation threshold, and the recommended preparation time is as described previously.

In the graph 101 in FIG. 13, the inspection result has been illustrated by a black circle. On the display screen 100, the replacement threshold has been illustrated as “Threshold 2” by a two-dot chain line, and the preparation threshold has been illustrated as “Threshold 3” by a two-dot chain line (two-dot chain line with a narrower interval). On the alarm display 103, the recommended replacement time and the recommended preparation time are displayed. Incidentally, as described previously, the thinning amount ratio indicating the replacement threshold is exemplified as 2.0, which is twice the thinning amount ratio indicating the inspection threshold.

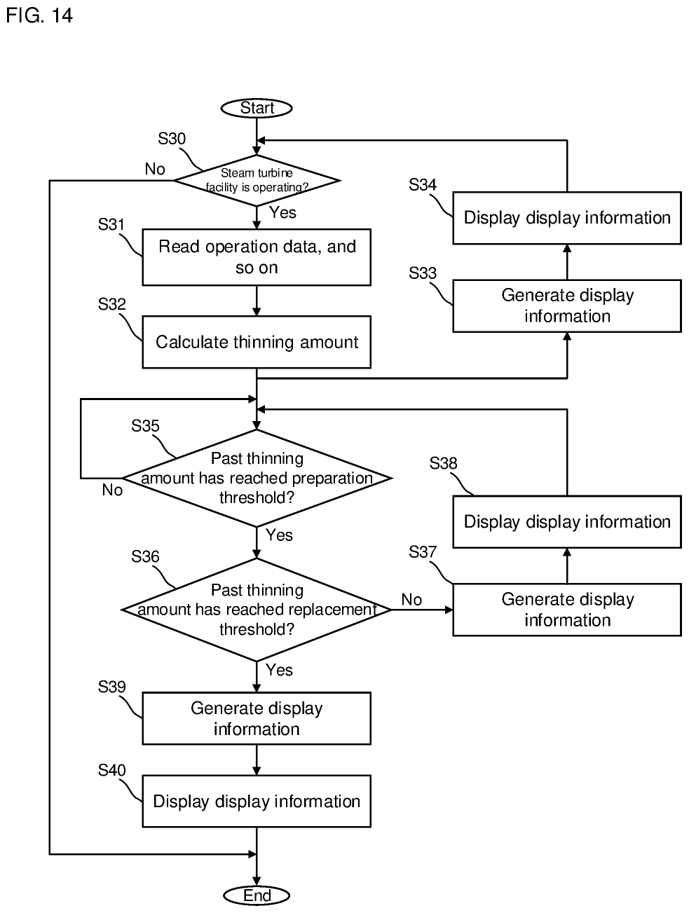

FIG. 14 is a flowchart for explaining the method of the fixed-cycle thinning amount arithmetic operation processing in the thinning amount managing apparatus 18 in the first embodiment.

As illustrated in FIG. 14, the fixed-cycle thinning amount arithmetic operation section 71 determines whether or not the steam turbine facility 1 is operating based on the information stored in the measurement data storage section 62, for example (Step S30). Then, the fixed-cycle thinning amount arithmetic operation section 71 executes pieces of processing at Step S30 to Step S34. Here, pieces of the processing at Step S30 to Step S34 are the same as those at Step S20 to Step S24 in FIG. 11, and thus their explanations are omitted.

After the processing at Step S32, the fixed-cycle thinning amount arithmetic operation section 71 determines whether or not the past thinning amount has reached the preparation threshold based on the arithmetic operation result (Step S35). Here, the case where the past thinning amount reaches the preparation threshold means that the past thinning amount reaches the preparation threshold based on the future prediction calculated by the future thinning amount arithmetic operation section 72.

When determining in the determination of Step S35 that the past thinning amount has not reached the preparation threshold (No at Step S35), the fixed-cycle thinning amount arithmetic operation section 71 executes the processing at Step S35 again.

When determining in the determination of Step S35 that the past thinning amount has reached the preparation threshold (Yes at Step S35), the fixed-cycle thinning amount arithmetic operation section 71 determines whether or not the past thinning amount has reached the replacement threshold based on the arithmetic operation result at Step S32 (Step S36).

When determining in the determination of Step S36 that the past thinning amount has not reached the replacement threshold (No at Step S36), the fixed-cycle thinning amount arithmetic operation section 71 outputs information on the year, month, and day when the past thinning amount reached the preparation threshold (information related to the recommended preparation time) to the arithmetic operation result storage section 64. The arithmetic operation result storage section 64 stores this information.

The display information generation section 73 generates display information based on the arithmetic operation result stored in the arithmetic operation result storage section 64 and the information stored in the template storage section 65 (Step S37). Then, the display information generation section 73 outputs the generated display information to the display information storage section 66 and the user interface 50. The display information storage section 66 stores the display information.

The user interface 50 updates the display screen based on the display information output from the display information generation section 73 (Step S37). By this update, the information on the recommended preparation time on the alarm display 103 illustrated in FIG. 13 is updated.

When determining in the determination of Step S36 that the past thinning amount has reached the replacement threshold (Yes at Step S36), the fixed-cycle thinning amount arithmetic operation section 71 outputs information on the year, month, and day when the past thinning amount reached the replacement threshold (information related to the recommended replacement time) and information related to the recommended preparation time to the arithmetic operation result storage section 64. The arithmetic operation result storage section 64 stores the information.

The display information generation section 73 generates display information based on the arithmetic operation result stored in the arithmetic operation result storage section 64 and the information stored in the template storage section 65 (Step S39). Then, the display information generation section 73 outputs the generated display information to the display information storage section 66 and the user interface 50. The display information storage section 66 stores the display information.

The user interface 50 updates the display screen based on the display information output from the display information generation section 73 (Step S40). By this update, the information on the recommended replacement time and the recommended preparation time on the alarm display 103 illustrated in FIG. 13 is updated.

The arithmetic operation of the past thinning amount in the fixed-cycle thinning amount arithmetic operation section 71 is executed, for example, every hour. Therefore, the information on the past thinning amount on the display screen 100 is updated every hour. Incidentally, when the time range on the horizontal axis is the same, the information on the past thinning amount in the graph 101 in FIG. 13 increases with the passage of time.

By the above-described fixed-cycle thinning amount arithmetic operation processing, the information on the past thinning amount on the display screen 100 illustrated in FIG. 12 and FIG. 13 is updated. Further, when the past thinning amount has reached the preparation threshold, or when the past thinning amount has reached the replacement threshold, the information on the alarm display 103 is updated.

### (Future Thinning Amount Arithmetic Operation Processing)

Next, there is explained future thinning amount arithmetic operation processing in the thinning amount managing apparatus 18 in the first embodiment. Incidentally, the explanation is made here based on the assumption that the thinning amount has not reached the inspection threshold when the thinning amount managing apparatus 18 is installed.

The future thinning amount arithmetic operation processing will be explained separately into pre-inspection arithmetic operation processing, which is before the inspection performed based on the fact that the thinning amount has reached the inspection threshold, and post-inspection arithmetic operation processing, which is after the inspection performed based on the fact that the thinning amount has reached the inspection threshold.

First, the pre-inspection arithmetic operation processing is explained.

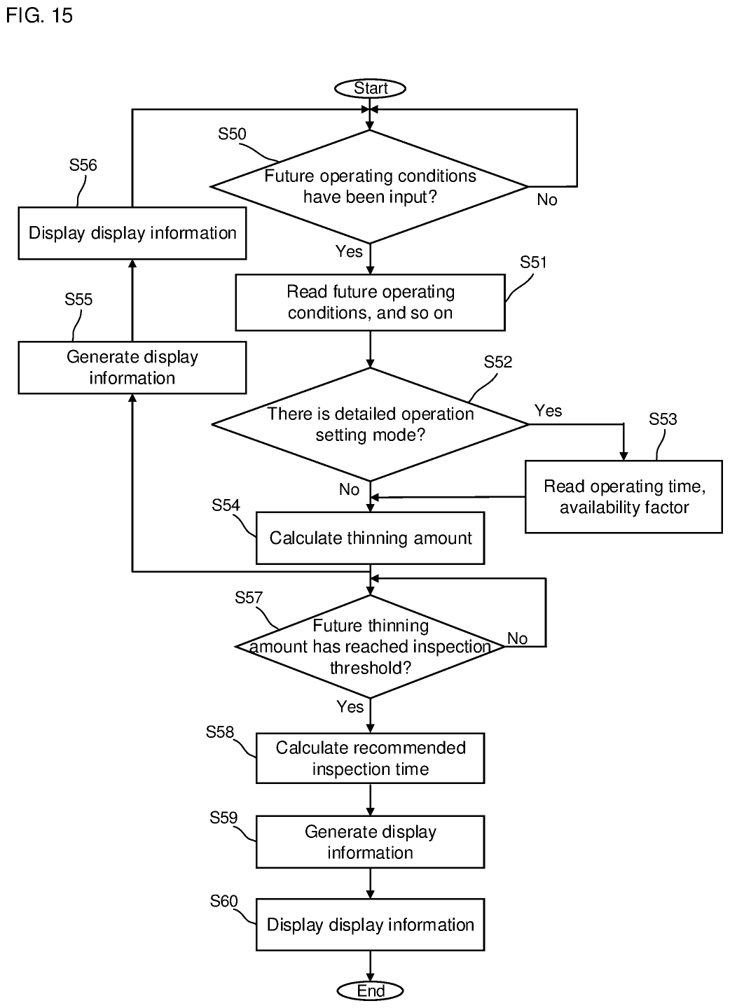

FIG. 15 is a flowchart for explaining a method of the future thinning amount arithmetic operation processing in the thinning amount managing apparatus 18 in the first embodiment. Incidentally, the replacement threshold has not been set because it is before inspection.

Here, as of the date of installation of the thinning amount managing apparatus 18, the future operating conditions illustrated in FIG. 3 have been set initially. After the installation, the user inputs the future operating conditions in units of one year via the input screen 80 illustrated in FIG. 3 in the user interface 50.

For example, by pressing a selection button 105 in a selection display portion 104 on the display screen 100 illustrated in FIG. 10, a selection item of the input screen 80 for future operating conditions is displayed in the selection display portion 104, although not illustrated. When the selection item of the input screen 80 is selected in the selection display portion 104, the screen of the display part of the user interface 50 is switched to the input screen 80 for future operating conditions illustrated in FIG. 3. At this time, the display information generation section 73 receives information related to the selection of the input screen 80 from the user interface 50 and outputs display information for displaying the input screen 80 to the user interface 50.

Then, after inputting the future operating conditions, the user presses the Save button 87 in FIG. 3. The user interface 50 receives input from the Save button 87 and outputs information related to the future operating conditions to the input information storage section 61. The input information storage section 61 stores the information related to the future operating conditions. Incidentally, the Back button 88 on the input screen 80 is a button to be pressed when returning to the display screen 100 without pressing the Save button 87.

Further, the future thinning amount arithmetic operation section 72 receives information from the user interface 50 in response to the press of the Save button 87, and determines that the future operating conditions have been input.

As illustrated in FIG. 15, the future thinning amount arithmetic operation section 72 determines whether or not the future operating conditions have been input (Step S50).

When determining in the determination of Step S50 that the future operating conditions have not been input (No at Step S50), the future thinning amount arithmetic operation section 72 executes the processing at Step S50 again.

When determining in the determination of Step S50 that the future operating conditions have been input (Yes at Step S50), the future thinning amount arithmetic operation section 72 reads the program for executing the arithmetic operation of the future thinning amount and the arithmetic expressions/equations and parameters for calculating the future thinning amount from the program storage section 63, the design information of the rotor blade to be managed from the input information storage section 61, and the future operating conditions stored in the input information storage section 61 (Step S51). Then, the future thinning amount arithmetic operation section 72 refers to the future operating conditions to determine whether or not there is the detailed operation setting mode (Step S52).

When determining in the determination of Step S52 that there is the detailed operation setting mode (Yes at Step S52), the future thinning amount arithmetic operation section 72 reads the information related to the operating time for each classified load under the future operating conditions, the information related to the availability factor, and the startup count information (Step S53).

Then, the future thinning amount arithmetic operation section 72 arithmetically operates the future thinning amount using the arithmetic operation method explained with reference to FIG. 7 and outputs the arithmetic operation result to the arithmetic operation result storage section 64 (Step S54). The arithmetic operation result storage section 64 stores the arithmetic operation result.

The display information generation section 73 generates display information based on the arithmetic operation result stored in the arithmetic operation result storage section 64 and the information stored in the template storage section 65 (Step S55). Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 12 (Step S56).

Here, the display information generation section 73 outputs the display information based on the arithmetic operation result to the display information storage section 66 and the user interface 50 each time the arithmetic operation processing of the future thinning amount is executed by the future thinning amount arithmetic operation section 72. Therefore, the graph 101 illustrating the arithmetic operation result regarding the future thinning amount displayed on the display part is updated each time the arithmetic operation processing of the future thinning amount is executed in the future thinning amount arithmetic operation section 72. In other words, the graph 101 illustrating the arithmetic operation result regarding the future thinning amount is updated each time the information in response to the press of the Save button 87 on the input screen 80 for future operating conditions is received.

Further, after the processing at Step S54, the future thinning amount arithmetic operation section 72 determines whether or not the future thinning amount has reached the inspection threshold based on the arithmetic operation result (Step S57).

When determining in the determination of Step S57 that the future thinning amount has not reached the inspection threshold (No at Step S57), the future thinning amount arithmetic operation section 72 executes the processing at Step S57 again. Incidentally, when the future thinning amount arithmetic operation section 72 receives a new future operating condition and performs arithmetic operation after determining that the future thinning amount has reached the inspection threshold at Step S57, there is sometimes a case that it is determined that the future thinning amount has not reached the inspection threshold at Step S57 of the arithmetic operation based on the new future operating condition. In this case, the future thinning amount arithmetic operation section 72 outputs information on the fact that there is no recommended inspection time to the arithmetic operation result storage section 64. The display information generation section 73 generates display information in which the alarm display 103 including the recommended inspection time has been deleted from the display screen 100 based on the arithmetic operation result stored in the arithmetic operation result storage section 64 and the information stored in the template storage section 65. The display information generation section 73 outputs the generated display information to the display information storage section 66 and the user interface 50. By this update, the alarm display 103 including the recommended inspection time is deleted from the display screen 100.

When determining in the determination of Step S57 that the future thinning amount has reached the inspection threshold (Yes at Step S57), the future thinning amount arithmetic operation section 72 calculates the recommended inspection time by the method explained with reference to FIG. 8 and FIG. 9, and outputs the calculation result to the arithmetic operation result storage section 64 (Step S58). The arithmetic operation result storage section 64 stores the recommended inspection time.

The display information generation section 73 generates display information based on the arithmetic operation result stored in the arithmetic operation result storage section 64 and the information stored in the template storage section 65 (Step S59). The display information generation section 73 generates display information for updating the alarm display 103 on the display screen 100 illustrated in FIG. 12.

Then, the display information generation section 73 outputs the generated display information to the display information storage section 66 and the user interface 50. The display information storage section 66 stores the display information.

The user interface 50 updates the display screen based on the display information output from the display information generation section 73 (Step S60). By this update, the alarm display 103 including the recommended inspection time based on the current calculation result is displayed on the display screen 100.

Next, the post-inspection arithmetic operation processing is explained.

Here, when executing the post-inspection arithmetic operation processing, the replacement threshold (for example, the thinning amount ratio of 2.0 illustrated in FIG. 13) has been determined as explained in the fixed-cycle thinning amount arithmetic operation processing. The line of the preparation threshold is not displayed in the graph 101 and the recommended replacement time and the recommended preparation time are not displayed on the alarm display 103 until the arithmetically operated future thinning amount reaches the replacement threshold. After the arithmetically operated future thinning amount reaches the replacement threshold, as illustrated in FIG. 13, for example, in the graph 101, the line of the replacement threshold (Threshold 2: two-dot chain line) and the line of the preparation threshold (Threshold 3: two-dot chain line with a narrower interval) are illustrated, and on the alarm display 103, the recommended replacement time and the recommended preparation time are displayed.

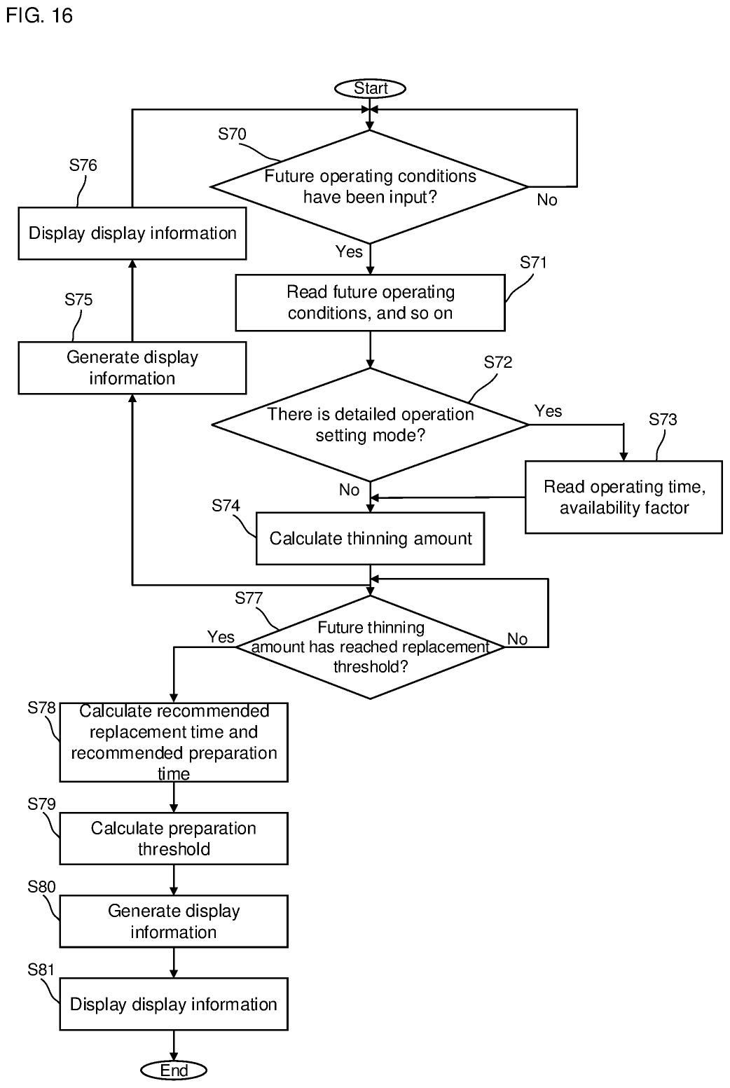

FIG. 16 is a flowchart for explaining the method of the future thinning amount arithmetic operation processing in the thinning amount managing apparatus 18 in the first embodiment.

As illustrated in FIG. 16, the future thinning amount arithmetic operation section 72 determines whether or not the future operating conditions have been input (Step S50). Then, the future thinning amount arithmetic operation section 72 executes pieces of processing at Step S70 to Step S76. Here, pieces of the processing at Step S70 to S76 are the same as those at Step S50 to Step S56 in FIG. 15, and thus their explanations are omitted.

After the processing at Step S74, the future thinning amount arithmetic operation section 72 determines whether or not the future thinning amount has reached the replacement threshold based on the arithmetic operation result (Step S77).

When determining in the determination of Step S77 that the future thinning amount has not reached the replacement threshold (No at Step S77), the future thinning amount arithmetic operation section 72 executes the processing at Step S77 again. Incidentally, when the future thinning amount arithmetic operation section 72 receives a new future operating condition and performs arithmetic operation after determining that the future thinning amount has reached the replacement threshold at Step S77, there is sometimes a case that it is determined that the future thinning amount has not reached the replacement threshold at Step S77 of the arithmetic operation based on the new future operating condition. In this case, the future thinning amount arithmetic operation section 72 outputs information on the fact that there is no recommended replacement time to the arithmetic operation result storage section 64. The display information generation section 73 generates display information in which the alarm display 103 including the recommended replacement time has been deleted from the display screen 100 based on the arithmetic operation result stored in the arithmetic operation result storage section 64 and the information stored in the template storage section 65. The display information generation section 73 outputs the generated display information to the display information storage section 66 and the user interface 50. By this update, the alarm display 103 including the recommended replacement time is deleted from the display screen 100.

When determining in the determination of Step S77 that the future thinning amount has reached the replacement threshold (Yes at Step S77), the future thinning amount arithmetic operation section 72 calculates the recommended replacement time and the recommended preparation time by the method explained with reference to FIG. 8 and FIG. 9, and outputs the calculation results to the arithmetic operation result storage section 64 (Step S78). The arithmetic operation result storage section 64 stores the recommended replacement time and the recommended preparation time.

Then, the future thinning amount arithmetic operation section 72 calculates the preparation threshold by the method explained with reference to FIG. 8 and FIG. 9 and outputs the preparation threshold to the arithmetic operation result storage section 64 (Step S79). The arithmetic operation result storage section 64 stores the preparation threshold.

The display information generation section 73 generates display information based on the arithmetic operation result stored in the arithmetic operation result storage section 64 and the information stored in the template storage section 65 (Step S80). The display information generation section 73 generates display information for displaying the alarm display 103 and the line of the preparation threshold of the graph 101 on the display screen 100.

Then, the display information generation section 73 outputs the generated display information to the display information storage section 66 and the user interface 50. The display information storage section 66 stores the display information.

The user interface 50 updates the display screen based on the display information output from the display information generation section 73 (Step S81). By this update, the alarm display 103 including the recommended replacement time and the recommended preparation time based on the current calculation result is displayed on the display screen 100. Further, in the graph 101, the line indicating the preparation threshold based on the current calculation result is displayed.

The arithmetic operation result of the future thinning amount in the future thinning amount arithmetic operation section 72 described above is obtained for each one-year cycle set as the future operating condition. That is, the arithmetic operation result in the future thinning amount arithmetic operation section 72 is obtained in units of one year.

In the future thinning amount arithmetic operation processing, the arithmetic operation processing is performed repeatedly each time the information in response to the press of the Save button 87 on the input screen 80 for future operating conditions is received. Then, the information on the future thinning amount on the display screen 100 is updated each time the information in response to the press of the Save button 87 on the input screen 80 for future operating conditions is received.

By the future thinning amount arithmetic operation processing described above, the information on the future thinning amount on the display screen 100 illustrated in FIG. and FIG. 13 is updated. For example, the information on the future thinning amount illustrated in the graph 101 varies depending on the future operating condition. Further, the recommended replacement time, the recommended preparation time, and the preparation threshold also vary depending on the future operating condition.

According to the thinning amount managing apparatus 18 in the first embodiment described above, the past thinning amount from the past to the present predicted based on the operation data of the actual steam turbine and the future thinning amount predicted based on the assumed future operating condition can be displayed in the graph 101 in chronological order on the display part of the user interface 50. This allows the user to visually confirm the variation in the thinning amount over time.

Further, in the thinning amount managing apparatus 18, lines indicating the replacement threshold and the preparation threshold can be displayed in the graph 101 on the display screen 100. This allows the user to visually confirm the recommended replacement time and the recommended preparation time.

Furthermore, in the thinning amount managing apparatus 18, the recommended replacement time and the recommended preparation time can be displayed on the display screen 100 as the alarm display 103. This allows the user to specifically recognize the recommended replacement time and the recommended preparation time. Then, by specifically recognizing the recommended preparation time, the user can accurately request the manufacture of the rotor blade to be replaced.

In the thinning amount managing apparatus 18, the arithmetic operation result of the future thinning amount based on the operating condition input on the input screen 80 for future operating conditions can be displayed. Therefore, by changing the operating condition on the input screen 80 for future operating conditions, the user can visually confirm the difference in the future thinning amount depending on the operating condition in the graph 101 on the display screen 100. Further, the user can visually confirm the difference between the recommended replacement time and the recommended preparation time depending on the future operating condition on the alarm display 103 on the display screen 100.

### Second Embodiment

In the second embodiment, there is explained another example of the information on the future thinning amount to be displayed on the display part of the user interface 50.

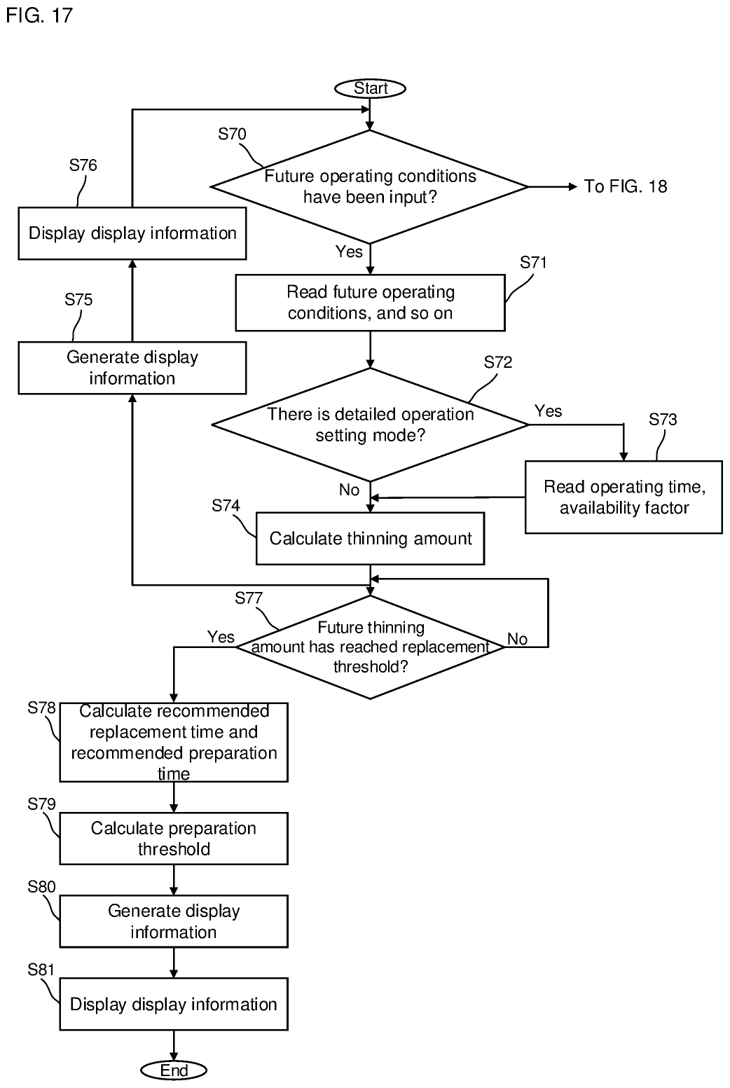

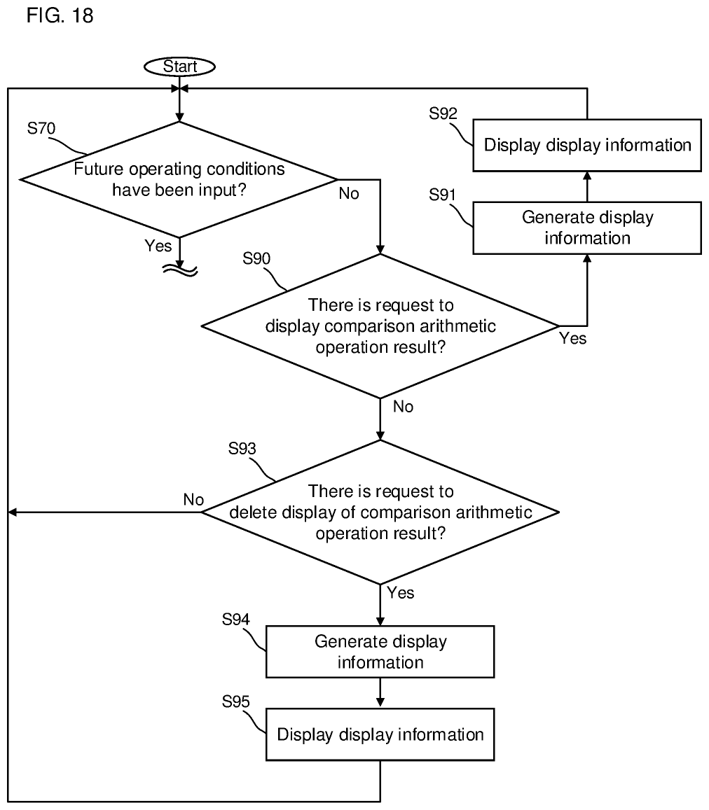

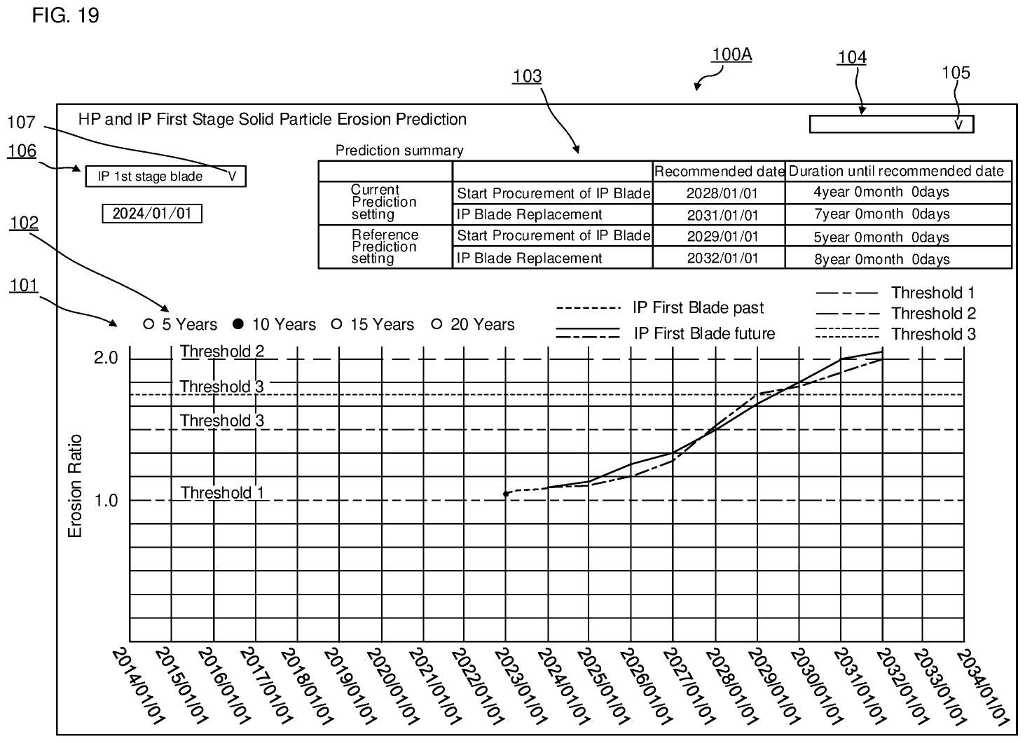

FIG. 17 and FIG. 18 are flowcharts for explaining a method of future thinning amount arithmetic operation processing in the thinning amount managing apparatus 18 in the second embodiment. Incidentally, the flowchart cannot be illustrated in one diagram due to the formation of the drawing, and thus the flowchart following “No” at Step S70 in FIG. 17 is illustrated in FIG. 18. FIG. 19 is a view illustrating one example of a display screen 100A in the thinning amount managing apparatus 18 in the second embodiment. Incidentally, in the second embodiment, the same reference numerals and symbols are added to the same components as those of the thinning amount managing apparatus 18 in the first embodiment, and redundant explanations are omitted or simplified.

Incidentally, the thinning amount ratio illustrated on the display screen 100A is exemplified by the thinning amount ratio when the thinning amount at the inspection threshold is set to 1, similarly to the display screen 100 in the first embodiment. Further, similarly to the display screen 100, the display screen 100A displays one example in which the thinning amount ratio indicating the replacement threshold is set to twice the thinning amount ratio indicating the inspection threshold.

The thinning amount managing apparatus 18 in the second embodiment differs from the thinning amount managing apparatus 18 in the first embodiment in that the arithmetic operation result under another future operating condition can be displayed simultaneously on the display screen 100A, which displays the arithmetic operation result of the thinning amount. Here, this different configuration is mainly explained. Incidentally, the fixed-cycle thinning amount arithmetic operation processing in the second embodiment is the same as that in the first embodiment.

In the future thinning amount arithmetic operation processing in the second embodiment illustrated in FIG. 17 and FIG. 18, pieces of processing at Step S90 to Step S95 have been added to the future thinning amount arithmetic operation processing in the first embodiment. Here, there is explained, as an example, the display screen 100A that displays the arithmetic operation results of the pre-inspection arithmetic operation processing and the post-inspection arithmetic operation processing in the future thinning amount arithmetic operation processing.

Here, the user presses the Save button 87 in FIG. 3 after inputting the future operating conditions. In the future thinning amount arithmetic operation processing in the second embodiment, as in the future thinning amount arithmetic operation processing in the first embodiment, the user interface 50 receives the input from the Save button 87 and outputs information related to the future operating conditions to the input information storage section 61. The input information storage section 61 stores the information related to the future operating conditions.

Further, the future thinning amount arithmetic operation section 72 receives information in response to the press of the Save button 87 from the user interface 50, and determines that the future operating conditions have been input.

As illustrated in FIG. 17, the future thinning amount arithmetic operation section 72 determines whether or not the future operating conditions have been input (Step S70).

When it is determined in the determination of Step S70 that the future operating conditions have been input (Yes at Step S70), pieces of the processing at Step S71 to Step S76 are executed as described previously. Then, as described previously, after the processing at Step S76, the processing at Step S70 is executed.

On the other hand, when it is determined in the determination of Step S70 that the future operating conditions have not been input (No at Step S70), the display information generation section 73 determines whether or not there is a request to display a result obtained by performing the arithmetic operation under another future operating condition (comparison arithmetic operation result) (Step S90), as illustrated in FIG. 18. The comparison arithmetic operation result is an arithmetic operation result that has already been predicted based on another future operating condition, and has been stored in the arithmetic operation result storage section 64. Incidentally, another future operating condition functions as a second future operating condition, and the comparison arithmetic operation result functions as second future thinning amount related information.

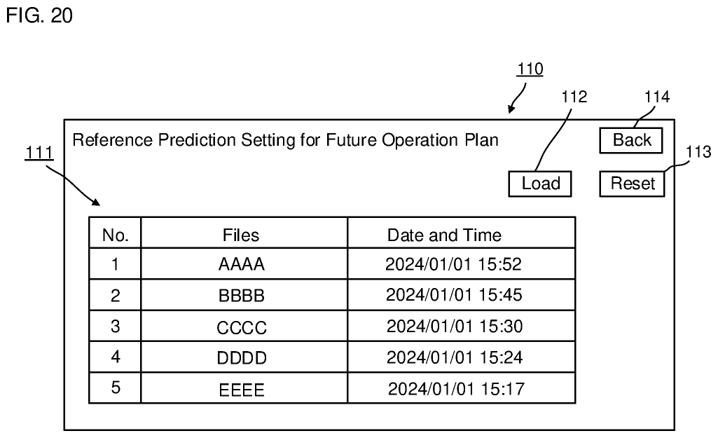

Here, FIG. 20 is a view illustrating one example of a selection screen 110 for selecting the comparison arithmetic operation result to be displayed on the user interface 50 in the thinning amount managing apparatus 18 in the second embodiment.

For example, by pressing the selection button 105 in the selection display portion 104 on the display screen 100 illustrated in FIG. 13, a selection item of the selection screen 110 is displayed in the selection display portion 104, although not illustrated. Then, when the selection item of the selection screen 110 is selected in the selection display portion 104, the screen of the display part of the user interface 50 is switched to the selection screen 110 illustrated in FIG. 20. At this time, the display information generation section 73 receives information related to the selection of the selection screen 110 from the user interface 50 and outputs display information for displaying the selection screen 110 to the user interface 50.

On the selection screen 110 in FIG. 20, a list of already arithmetically operated arithmetic operation results, which are stored in the arithmetic operation result storage section 64, is displayed in a list display portion 111. Further, there has been illustrated one example of the list display portion 111 that also displays dates and times stored in the arithmetic operation result storage section 64 here. In the list display portion 111, for example, file names of five arithmetic operation results are displayed in order of the latest date and time stored in the arithmetic operation result storage section 64. Incidentally, the structure displayed in the list display portion 111 is not limited to this. In the list display portion 111, a list of arithmetic operation results that have already been arithmetically operated only needs to be displayed.

Here, FIG. 20 illustrates one example of comparison arithmetic operation results that were arithmetically operated based on the future operating conditions within the past 1 hour. Therefore, the comparison arithmetic operation results can be compared without the latest future thinning amount being updated. That is, no matter which of these comparison arithmetic operation results is displayed in the graph 101 on the display screen 100A, the starting point of the line indicating the future thinning amount ratio in the comparison arithmetic operation result coincides with the starting point of the line indicating the latest future thinning amount ratio, as illustrated in FIG. 19.

Incidentally, the comparison arithmetic operation result may be a result arithmetically operated more than one hour ago. For example, when selecting a comparison arithmetic operation result arithmetically operated several days ago, the starting point of the line indicating the future thinning amount ratio in the comparison arithmetic operation result will deviate from the starting point of the line indicating the latest future thinning amount ratio. Even when the respective starting points deviate as above, the variation trends in the thinning amount ratio in the future can be compared.

The user selects the file name of the arithmetic operation result that the user wants to display on the display screen 100 illustrated in FIG. 13 as the comparison arithmetic operation result from the list displayed on the list display portion 111. Then, the user presses a Load button 112. When the user presses the Load button 112, the screen is switched to the display screen 100A to display the arithmetic operation results illustrated in FIG. 19.

Incidentally, a Back button 114 on the selection screen 110 is a button to be pressed when returning to the display screen 100 without pressing the Load button 112 or a Reset button 113.

The display information generation section 73 receives a signal based on the press of the Load button 112 from the user interface 50, and determines at Step S90 that there is a request to display the comparison arithmetic operation result.

When determining in the determination of Step S90 that there is a request to display the comparison arithmetic operation result (Yes at Step S90), the display information generation section 73 generates display information based on the arithmetic operation result stored in the arithmetic operation result storage section 64 and the information stored in the template storage section 65 (Step S91). Here, the display information generation section 73 reads both the arithmetic operation result based on the future operating condition stored in the arithmetic operation result storage section 64 and the selected comparison arithmetic operation result. Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 19 (Step S92). As illustrated in FIG. 19, on the display screen 100A, both the arithmetic operation result based on the future operating condition and the comparison arithmetic operation result are displayed as the future thinning amount.

Specifically, the thinning amount ratio in each of the arithmetic operation results is illustrated in chronological order, and at the same time, the line of the preparation threshold in each of the arithmetic operation results is illustrated. Incidentally, the thinning amount ratio in the comparison arithmetic operation result has been illustrated by a dot and dash line, and the line of the preparation threshold in the comparison arithmetic operation result (Threshold 3) has been illustrated by a dotted line. Further, as the alarm display 103, the recommended replacement times and the recommended preparation times in the respective arithmetic operation results are displayed. Incidentally, as illustrated in FIG. 19, the thinning amount ratio in the past thinning amount has also been illustrated in chronological order.

Incidentally, the preparation threshold in the comparison arithmetic operation result functions as a second preparation threshold, the recommended replacement time in the comparison arithmetic operation result functions as a second recommended replacement time, and the recommended preparation time in the comparison arithmetic operation result functions as a second recommended preparation time.

When determining in the determination of Step S90 that there is no request to display the comparison arithmetic operation result (No at Step S90), the display information generation section 73 determines whether or not there is a request to delete the display of the comparison arithmetic operation result (Step S93).

Here, the user can delete the comparison arithmetic operation result displayed on the display screen 100A in FIG. 19 by pressing the Reset button 113 on the selection screen 110 in FIG. 20. The display information generation section 73 receives a signal based on the press of the Reset button 113 from the user interface 50, and determines at Step S93 that there is a request to delete the display of the comparison arithmetic operation result. Incidentally, when the user presses the Reset button 113, the screen is switched to the display screen to display the arithmetic operation results.

When determining in the determination of Step S93 that there is a request to delete the display of the comparison arithmetic operation result (Yes at Step S93), the display information generation section 73 generates display information based on the arithmetic operation result stored in the arithmetic operation result storage section 64 and the information stored in the template storage section 65 (Step S94). Here, the display information generation section 73 reads the arithmetic operation result based on the future operating condition stored in the arithmetic operation result storage section 64. Then, the display information generation section 73 outputs the generated display information to the display information storage section 66 and the user interface 50. The display information storage section 66 stores the display information.

The user interface 50 displays the display information output from the display information generation section 73 on the display part as illustrated in FIG. 13 (Step S95). That is, as illustrated in FIG. 13, on the display screen 100, the comparison arithmetic operation result is deleted and only the arithmetic operation results based on the future operating conditions are displayed.

When it is determined in the determination of Step S93 that there is no request to delete the display of the comparison arithmetic operation result (No at Step S93), the operation returns to the processing at Step S70.

Further, as illustrated in FIG. 17, after the processing at Step S74, the future thinning amount arithmetic operation section 72 determines whether or not the thinning amount has reached the replacement threshold based on the arithmetic operation result at Step S74, as described previously (Step S77). Then, as described previously, pieces of the processing at Step S77 to Step S81 are executed.

The information on the future thinning amount on the display screen 100A is updated each time the information in response to the press of the Save button 87 on the input screen 80 for future operating conditions and the press of the Load button 112 or the Reset button 113 on the selection screen 110 for comparison arithmetic operation results is received.

Incidentally, although there has been explained one example in which one arithmetic operation result is selected as the comparison arithmetic operation result here, the present invention may be set so that a plurality of comparison arithmetic operation results can be selected.

According to the thinning amount managing apparatus 18 in the second embodiment described above, the same operations and effects as those of the thinning amount managing apparatus 18 in the first embodiment can be obtained.

Further, according to the thinning amount managing apparatus 18 in the second embodiment, both the arithmetic operation result predicted based on the future operating condition and the comparison arithmetic operation result can be displayed on the display screen 100A as the future thinning amount.

Thereby, the user can visually confirm the difference between the thinning amount in the arithmetic operation result based on the future operating condition and the thinning amount in the comparison arithmetic operation result in the graph 101 on the display screen 100A. In addition, the user can visually confirm the difference between the recommended replacement time and the recommended preparation time in the arithmetic operation result based on the future operating condition and the recommended replacement time and the recommended preparation time in the comparison arithmetic operation result on the alarm display 103 on the display screen 100A.

According to the embodiments described above, it is possible to recognize in chronological order the thinning amount from the past to the present predicted based on the operation data and the future thinning amount predicted based on the future operating conditions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A steam turbine rotor blade thinning amount managing apparatus for managing an amount of thinning of a first-stage rotor blade of a steam turbine caused by solid particles contained in working steam for working the steam turbine, the steam turbine rotor blade thinning amount managing apparatus comprising
a display information generation section configured to generate display information for displaying:
past thinning amount related information indicating information on a past thinning amount of the first-stage rotor blade from the past to the present calculated based on measured information; and
future thinning amount related information indicating information on a future thinning amount of the first-stage rotor blade calculated based on a future operating condition input via a user interface screen and the past thinning amount related information.

2. The steam turbine rotor blade thinning amount managing apparatus according to claim 1, wherein
the display information generation section generates the display information for displaying both the information on the past thinning amount and the information on the future thinning amount in chronological order.

3. The steam turbine rotor blade thinning amount managing apparatus according to claim 1, wherein
the display information generation section generates the display information for displaying the past thinning amount related information at predetermined time intervals.

4. The steam turbine rotor blade thinning amount managing apparatus according to claim 1, wherein
the display information generation section generates the display information for displaying the future thinning amount related information each time the future operating condition is input.

5. The steam turbine rotor blade thinning amount managing apparatus according to claim 1, wherein
the display information generation section generates the display information for displaying a recommended inspection time for inspecting the first-stage rotor blade, the recommended inspection time is calculated based on the future thinning amount.

6. The steam turbine rotor blade thinning amount managing apparatus according to claim 1, wherein
the display information generation section generates the display information for displaying a recommended replacement time for replacing the first-stage rotor blade, the recommended replacement time is calculated based on the future thinning amount.

7. The steam turbine rotor blade thinning amount managing apparatus according to claim 1, wherein
the display information generation section generates the display information for displaying information related to a preparation threshold that is calculated based on the future thinning amount and that indicates a thinning amount at which it is recommended to start preparation for a new first-stage rotor blade.

8. The steam turbine rotor blade thinning amount managing apparatus according to claim 1, wherein
the display information generation section generates the display information for displaying a recommended preparation time for starting preparation for a new first-stage rotor blade, the recommended preparation time is calculated based on the future thinning amount.

9. The steam turbine rotor blade thinning amount managing apparatus according to claim 1, wherein
the display information generation section generates the display information for further displaying second future thinning amount related information indicating information on a second future thinning amount of the first-stage rotor blade calculated based on a second future operating condition input via the user interface screen and the past thinning amount related information.

10. The steam turbine rotor blade thinning amount managing apparatus according to claim 9, wherein
the display information generation section generates the display information for displaying a second recommended inspection time for inspecting the first-stage rotor blade, the second recommended inspection time is calculated based on the second future thinning amount.

11. The steam turbine rotor blade thinning amount managing apparatus according to claim 9, wherein
the display information generation section generates the display information for displaying information related to a second preparation threshold that is calculated based on the second future thinning amount and that indicates a thinning amount at which it is recommended to start preparation for a new first-stage rotor blade.

12. The steam turbine rotor blade thinning amount managing apparatus according to claim 9, wherein
the display information generation section generates the display information for displaying a second recommended preparation time for starting preparation for a new first-stage rotor blade, the second recommended preparation time is calculated based on the second future thinning amount.

13. The steam turbine rotor blade thinning amount managing apparatus according to claim 9, wherein
the display information generation section generates the display information for displaying a second recommended replacement time for replacing the first-stage rotor blade, the second recommended replacement time is calculated based on the second future thinning amount.
